(19) United States
(12) Patent Application Publication
(10) Pub. No.: US 2025/0320754 A1
(43) Pub. Date: Oct. 16, 2025

(54) ANTI-TIPPING MECHANISM, FURNITURE APPARATUS INCLUDING ANTI-TIPPING MECHANISM AND METHOD OF MANUFACTURING SAME

(71) Applicant: Night and Day Furniture LLC, Vancouver, WA (US)

(72) Inventor: Hadianto TAUFIK, Sumatera Utara (ID)

(73) Assignee: Night and Day Furniture LLC, Vancouver, WA (US)

(21) Appl. No.: 19/176,818

(22) Filed: Apr. 11, 2025

Related U.S. Application Data
(60) Provisional application No. 63/632,619, filed on Apr. 11, 2024.

(51) Int. Cl. E05B 65/464; A47B 88/45; A47B 97/00

(52) U.S. Cl. CPC E05B 65/464; A47B 88/45; A47B 97/00; A47B 2097/008

(57) ABSTRACT

An anti-tipping apparatus configured to inhibit opening of plural ones of a plurality of drawers may include at least one shaft; and stopping blocks arranged to move within the at least one shaft when the stopping blocks interact with rails attached to drawers such that, when one of the drawers opens, a pair of the stopping blocks are split by one or more of the rails to reposition one or more of the stopping blocks such that other ones of the drawers are inhibited from being open by one of the one or more stopping blocks that are repositioned.

### RELATED APPLICATIONS

This application claims priority under 35 U.S.C. § 119 to U.S. Provisional Application No. 63/632,619 filed on Apr. 11, 2024, the entire contents of which is hereby incorporated by reference in its entirety.

### BACKGROUND

### Field

Various example embodiments are related to an anti-tipping mechanism, furniture apparatus such as chests and dressers including an anti-tipping mechanism, and methods of manufacturing same.

### Description of the Related Art

Furniture tipping accidents may cause injury and tragically death especially when such accidents involve toddlers. Often, top drawers of a furniture apparatus may have heavy contents in them further making the furniture apparatus easier to tip over. Conventional anti-tipping mechanisms may require securing an upper back of the furniture apparatus to a wall or other support, which may be difficult and inconvenient. Further, while other conventional anti-tipping mechanisms may be utilized these conventional methods may be costly and impractical. Additionally, while conventional anti-tipping mechanisms may inhibit the opening of one drawer while another drawer is already open, such conventional anti-tipping mechanisms may be circumvented by allowing a user to open two drawers at the same time by, for example, opening one drawer with one hand while at the same time opening another drawer with another hand. Thwarting such circumvention may become more difficult when the furniture apparatus includes non-aligned rows of drawers that may be difficult to integrate within the same anti-tipping mechanism.

### SUMMARY

Example embodiments relate to anti-tipping mechanisms and furniture apparatuses including the same.

Example embodiments provide that a furniture apparatus may be a chest, a dresser, a cabinet, coffer, bureau, armoire, nightstand, desk, or any other like furniture apparatus that may include drawers and an anti-tipping mechanism to inhibit simultaneous opening of plural ones of the drawers.

At least one example embodiment relates to an anti-tipping mechanism configured to inhibit opening of plural ones of a plurality of drawers.

In some example embodiments, the anti-tipping mechanism includes at least one shaft; and stopping blocks arranged to move within the at least one shaft when the stopping blocks interact with rails attached to drawers such that, when one of the drawers opens, a pair of the stopping blocks are split by one or more of the rails to reposition one or more of the stopping blocks such that other ones of the drawers are inhibited from being opened by one of the one or more stopping blocks that are repositioned.

In some example embodiments, the stopping blocks include one or more of vertical stopping blocks each configured to interact with side rails fixedly attached to side surfaces of a respective one of the drawers; and horizontal stopping blocks each configured to interact with a bottom rail fixedly attached to a bottom surface of a respective one of the drawers.

In some example embodiments, the vertical stopping blocks include lower vertical stopping blocks and a set of upper vertical stopping block, and the horizontal stopping blocks include pairs of interior horizontal stopping blocks and a pair of end horizontal stopping blocks.

In some example embodiments, the lower vertical stopping blocks are configured to interact with the side rails fixedly attached to side surfaces of the plurality of drawers when corresponding ones of the plurality of drawers are opened or closed, and the set of upper vertical stopping blocks are configured to interact with respective ones of pair of end horizontal stopping blocks when corresponding ones of the plurality of drawers are opened or closed.

Some example embodiments relate to a furniture apparatus including the anti-tipping apparatus; and the plurality of drawers each having the one or more rails fixedly attached to side surfaces or a bottom surface thereof, the one or more rails having a sloped end surface.

In some example embodiments, the furniture apparatus further includes a frame including stiles each forming one of the at least one shaft.

Some example embodiments relate to an anti-tipping mechanism configured to inhibit opening of plural ones of a plurality of drawers.

In some example embodiments, the anti-tipping mechanism includes an interlocking mechanism including stopping blocks arranged within a shaft in a direction perpendicular to one or more rails fixedly attached to side surfaces of the plurality of drawers, a number of the stopping blocks being at least one less than a number of the plurality of drawers, the stopping blocks configured to interact with the one or more rails such that, when each of the plurality of drawers are closed, each of the stopping blocks are in a first position to interact with at least respective ones of the plurality of drawers below an uppermost one of the plurality of drawers, and when one of the plurality of drawers is an open drawer, the stopping blocks associated with the open drawer and ones of the plurality of drawers thereabove are positioned at a second position within the shaft in response to a sloped end surface of a corresponding one of the one or more rails of the open drawer contacting a respective one of the stopping blocks to inhibit the opening of the ones of the plurality of drawers above the open drawer while the stopping blocks below the open drawer remain in the first position and are inhibited from moving vertically to the second position due to extension of the corresponding one of the one or more rails to inhibit opening of ones of the plurality of drawers below the open drawer.

In some example embodiments, each of the stopping blocks are configured to interact with a respective pair of drawers of the plurality of drawers such that, in the first position, each of the stopping blocks inhibits opening of a lower one of the respective pair of drawers, and in the second position, each of the stopping blocks inhibits opening of an upper one of the pair of drawers.

In some example embodiments, the stopping blocks have a sloped lower end surface configured to interact with one of the one or more rails of the lower one of the respective pair of drawers when in the first position and a notched upper end surface configured to interact with one of the pair of the rails of the upper one of the respective pair of drawers when in the second position.

In some example embodiments, the one or more rails each include at least one sloped end surface.

In some example embodiments, a front end and a rear end of each of the one or more rails are sloped such that a front end surface interacts with one of the stopping blocks when one of the plurality of drawers is opened and a rear end surface interacts with one of the stopping blocks when one of the plurality of drawers is inserted.

In some example embodiments, the stopping blocks are formed of strips of wood.

In some example embodiments, the anti-tipping mechanism further includes a stile having a rabbet extending in a length direction thereof such that the stile includes a first portion and a second portion with the first portion being narrower than the second portion in a direction perpendicular to the length direction; and a plate attached to the stile and extending to cover a portion of the rabbet to create the shaft for the stopping blocks within the stile.

In some example embodiments, the stopping blocks each include a ledge extending from a side surface thereof such that the ledge is configured to travel within the rabbet in the stile.

In some example embodiments, while one or more of the stopping blocks is held in the second position by an open one of the plurality of drawers, the anti-tipping apparatus inhibits opening of another one of the plurality of drawers.

In some example embodiments, when two or more of the plurality of drawers are attempted to be opened simultaneously, the anti-tipping apparatus inhibits opening of each of the two or more of the plurality of drawers such that none of the plurality of drawers are openable.

Some example embodiments are directed to a method of manufacturing an anti-tipping apparatus configured to inhibit opening of plural ones of a plurality of drawers.

In some example embodiments, the method includes inserting stopping blocks into a frame of a furniture apparatus such that the stopping blocks are arranged within a shaft in a first direction, each of the stopping blocks being configured to interact with one or more rails fixedly attached to side surfaces of respective ones of the plurality of drawers such that, when each of the plurality of drawers are closed, each of the stopping blocks are in a first position to interact with at least respective ones of the plurality of drawers below an uppermost one of the plurality of drawers, and when one of the plurality of drawers is an open drawer, the stopping blocks associated with the open drawer and ones of the plurality of drawers thereabove move vertically within the shaft to a second position in response to a sloped end surface of a corresponding one of the one or more rails of the open drawer contacting a respective one of the stopping blocks to inhibit the opening of the ones of the plurality of drawers above the open drawer while the stopping blocks below the open drawer remain in the first position and are inhibited from moving vertically to the second position due to extension of the corresponding one of the one or more rails to inhibit opening of ones of the plurality of drawers below the open drawer, wherein the stopping blocks are formed of strips of wood.

In some example embodiments, the inserting inserts a number of the stopping blocks such that the number of the stopping blocks is at least one less than a number of the plurality of drawers.

In some example embodiments, the method further includes securing plates to a stile having a rabbet extending in a length direction thereof such that the plates cover a portion of the rabbet to create the shaft for the stopping blocks within the stile.

Some example embodiments are directed to an anti-tipping apparatus configured to inhibit opening of plural ones of a plurality of drawers.

In some example embodiments, the anti-tipping apparatus includes an interlocking mechanism including, sets of horizontal stopping blocks configured to interact with a rail fixedly attached to a bottom of a respective one of the plurality of drawers; and vertical stopping blocks including lower vertical stopping blocks and a set of upper vertical stopping blocks, the lower vertical stopping blocks configured to interact with one or more rails fixedly attached to side surfaces of the plurality of drawers, and the set of upper vertical stopping blocks configured to interact with respective end horizontal stopping blocks among the sets of horizontal stopping blocks, wherein when each of the plurality of drawers are closed, each of the lower vertical stopping blocks are in a first position to interact with respective ones of the plurality of drawers except an uppermost one of the plurality of drawers and the sets of horizontal stopping blocks are free to move horizontally in opposite directions when the rail fixedly attached to the bottom of a respective one of the plurality of drawers associated with the set of horizontal stopping blocks moves while the drawer is opened, when a lower one of the plurality of drawers is an open drawer, the vertical stopping blocks associated with the open drawer and ones of the plurality of drawers thereabove are at a second position different from the first position in response to a sloped end surface of a corresponding one of the one or more rails of the open drawer contacting a respective one of the vertical stopping blocks to inhibit the opening of the ones of the plurality of drawers above the open drawer while the vertical stopping blocks below the open drawer remain in the first position and are inhibited from moving vertically to the second position due to extension of the corresponding one of the one or more rails to inhibit opening of ones of the plurality of drawers below the open drawer, and when one of the uppermost one of the plurality of drawers is an open drawer, the horizontal stopping blocks associated with the open drawer move horizontally in opposite directions to both inhibit other ones of the sets of horizontal stopping blocks from being movable horizontally such that other uppermost ones of the plurality of drawers are inhibited from opening while the respective end horizontal stopping blocks are positioned to inhibit the vertical stopping blocks from being movable vertically from the first position to the second position such that each of the lower ones of the plurality of drawers is inhibited from opening.

Further areas of applicability will become apparent from the description and figures provided herein. It should be understood that the description and specific examples are intended for purposes of illustration only and are not intended to limit the scope of the present disclosure.

### BRIEF DESCRIPTION OF THE DRAWINGS

FIGS. 1a to 5c illustrate a furniture apparatus having an anti-tipping mechanism according to example embodiments;

FIG. 6 illustrates a method of manufacturing a furniture apparatus including an anti-tipping mechanism according to example embodiments;

FIG. 7 illustrates the insertion or closing of a drawer of the furniture apparatus having an anti-tipping mechanism according to example embodiments;

FIG. 8 illustrates a three-dimensional perspective view of a furniture apparatus with a side wall and support ledges omitted for illustration purposes according to example embodiments;

FIG. 9 illustrates left hand facing and right hand facing inside views of the side panels of a furniture apparatus according to example embodiments;

FIG. 10 illustrates a stopping block included in an anti-tipping mechanism according to according to example embodiments; and

FIGS. 11 to 13 illustrate a shaft and a metal plate used to form the shaft according to example embodiments.

FIGS. 14a to 21c illustrate a furniture apparatus having an anti-tipping mechanism according to other example embodiments;

FIG. 22 illustrates a method of manufacturing a furniture apparatus including an anti-tipping mechanism according to example embodiments;

FIGS. 23 to 25 illustrates the insertion or closing of drawers of the furniture apparatus having an anti-tipping mechanism according to example embodiments;

FIG. 26 illustrates an isolated front view of the anti-tipping mechanism in the frame of the furniture apparatus according to example embodiments;

FIG. 27 illustrates left hand facing and right hand facing inside views of the side panels according to example embodiments;

FIGS. 28 to 31 illustrate stopping blocks included in an anti-tipping mechanism according to according to example embodiments; and

FIGS. 32 to 34 illustrate a shaft and a metal plate used to form the shaft according to some example embodiments.

FIGS. 35 to 37 illustrate a shaft and a metal plate used to form the shaft according to some other example embodiments.

FIG. 38 illustrates an upper drawer according to example embodiments; and

FIG. 39 illustrates a lower drawer according to example embodiments.

### DETAILED DESCRIPTION

The following description is merely example in nature and is not intended to limit the present disclosure, application, or uses. It should be understood that throughout the drawings, corresponding reference numerals indicate like or corresponding parts and features.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein, the term “and/or” includes any and all combinations of one or more of the associated listed items.

It will be understood that, although the terms first, second, third etc. may be used herein to describe various elements, components, regions, portions, and/or sections, these elements, components, regions, portions, and/or sections should not be limited by these terms. These terms are only used to distinguish one element, component, region, portion, or section from another element, component, region, portion, or section. Thus, a first element, component, region, portion, or section discussed below could be termed a second element, component, region, portion, or section without departing from the scope of the example embodiments.

Certain terminology is used herein for purposes of reference only, and thus is not intended to be limiting. For example, terms such as “upper,” “lower,” “above,” “below,” “top,” “bottom,” “upward,” “downward,” “upwardly,” “downwardly,” “forward,” “rearward,” and the like refer to directions in the drawings to which reference is made. Terms such as “front,” “back,” “rear,” “bottom,” “side,” and the like describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first,” “second,” and other such numerical terms referring to structures do not imply a sequence or order unless clearly indicated by the context.

Example embodiments will now be described more fully with reference to the accompanying drawings. Example embodiments may, however, be embodied in many different forms and should not be construed as being limited to the example embodiments set forth herein. Rather, these example embodiments are provided so that this disclosure will be thorough, and will fully convey the example embodiments to those skilled in the art.

Example embodiments relate to anti-tipping mechanisms and furniture apparatuses including the same. Example embodiments provide that the furniture apparatus may be a chest, a chest of drawers, a cabinet, a coffer, a bureau, an armoire, a nightstand, a desk, or any other like furniture object or apparatus that may be configured to include and/or contain drawers and an anti-tipping mechanism configured to inhibit simultaneous opening of plural ones of the drawers.

The anti-tipping mechanisms and furniture apparatuses may be in a shape and configuration as shown by the accompanying figures. The anti-tipping mechanisms and furniture apparatuses may be operated according to methods as shown by the accompanying figures.

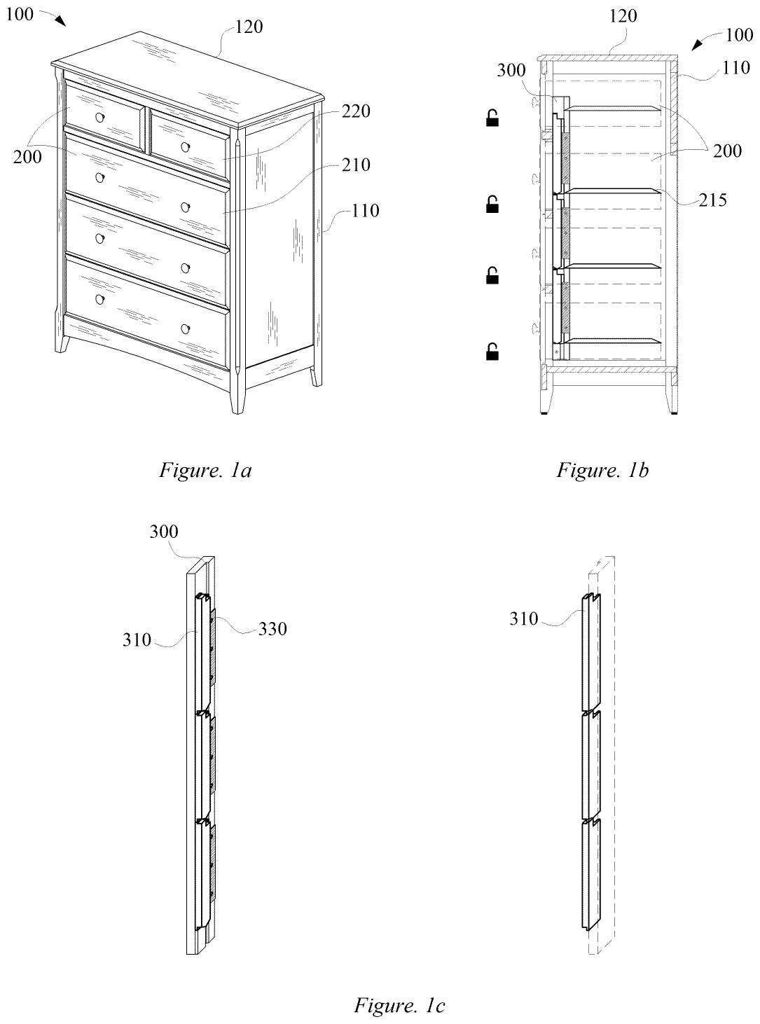

FIGS. 1-5 illustrate a furniture apparatus having an anti-tipping mechanism according to example embodiments. FIGS. 1a, 2a, 3a, 4a and 5a are three-quarter perspective views of a furniture apparatus in various states. FIGS. 1b, 2b, 3b, 4b and 5b are side sectional views of the furniture apparatus in the same various states. FIGS. 1c, 2c, 3c, 4c, and 5c are isolated views of an interlocking mechanism included in the furniture apparatus in the same various states.

Referring to FIGS. 1a to 5c, a furniture apparatus 100 may include a frame 110, a plurality of drawers 200 and an anti-tipping mechanism 300 in the form of an interlocking mechanism within the frame of the furniture apparatus. In some example embodiments, the plurality of drawers 200 may each have a pair of rails 215 fixedly attached to respective side surfaces thereof. The plurality of drawers 200 may include lower drawers 210 and upper drawers 220.

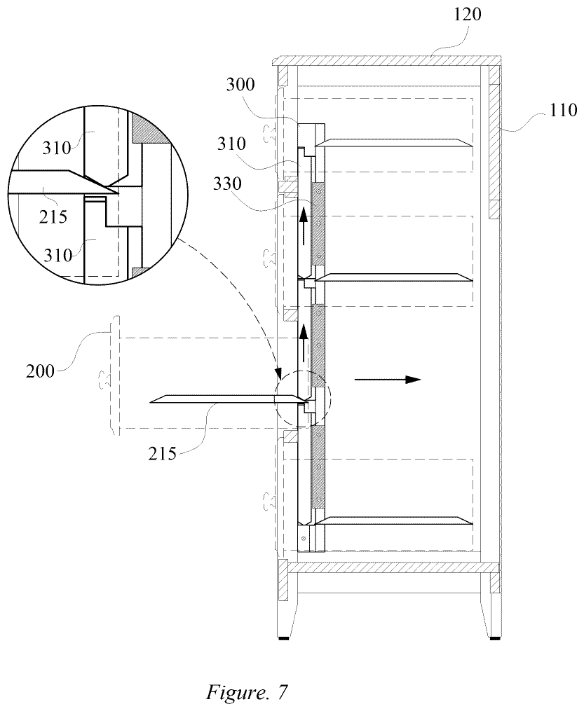

In some example embodiments, the pair of rails 215 may have at least one sloped end surface. For example, at least a front end surface of the pair of rails 215 may be sloped to allow the front sloped end surface of the rails 215 to interact with the interlocking mechanism 300 when the drawers 200 are opened. In other example embodiments, as discussed in more detail below with reference to FIG. 7, both the front and rear end surfaces of the pair of rails 215 may be sloped to additional allow the rear slopped end surface of the rails 215 to interact with the interlocking mechanism 300 when the drawers 200 are inserted into the furniture apparatus 100.

In some example embodiments, the interlocking mechanism 300 may include stopping blocks 310 arranged to extend vertically within a shaft 320 within the frame 110 such that each of the stopping blocks 310 are configured to interact with respective pairs of the plurality of drawers 200. In some example embodiments, the stopping blocks 310 may be configured to move vertically between a first position and a second position, such that, in the first position, the stopping blocks 310 inhibit opening of a lower one of the respective pairs of drawers 200 and, in the second position, the stopping blocks 310 inhibit opening of an upper one of the respective pair of drawers 200. In some example embodiments, a number of the stopping blocks 310 may be one less than a number of rows of the drawers 200 such that none of the stopping blocks are in the first position with regards to an uppermost one of the plurality of drawers 200. However, example embodiments are not limited thereto, and a number of the stopping blocks 310 may be at least one less than a number of rows of the drawers 200. In some example embodiments, the stopping blocks 310 may be formed from wood, for example, left-over scrap strips of pieces of wood that are remnants remaining from the formation of the furniture apparatus 100 as well as other furniture within a furniture factory. However, example embodiments are not limited thereto. For example, the stopping blocks 310 may be formed from other materials such as plastics.

For example, as illustrated in FIGS. 1a to 1c, when each of the drawers 200 are closed and the furniture apparatus 100 is at rest, each of the stopping blocks 310 is in the first position such that one of the stopping blocks 310 is aligned to interact with the rails 215 of each of the drawers 200 except the upper drawers 220. As such, the upper drawer 220 may freely open without interacting with a stopping block 310, while opening of the rest of the drawers 200 may open but such opening results in the drawers 200 interacting with respective stopping blocks 310 arranged at the first position.

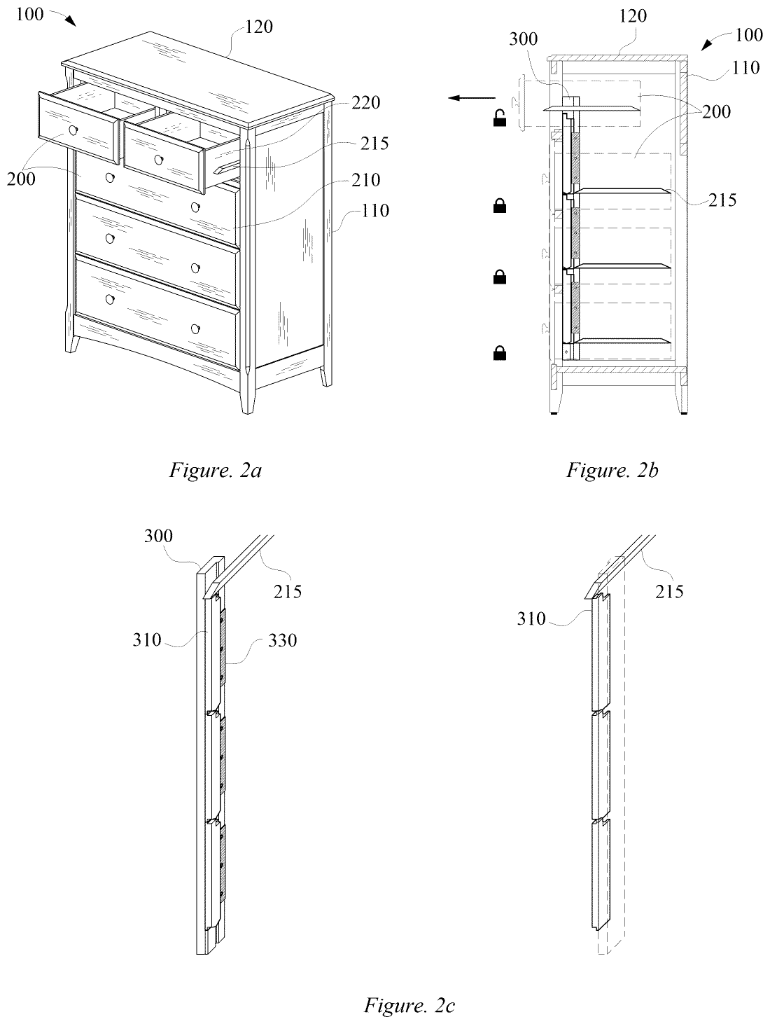

As illustrated in FIGS. 2a to 2c, upon opening the upper drawer 220, the pair of rails of the top drawer prohibit the stopping blocks 310 therebelow from moving vertically upwards from the first position to the second position, which is higher than the first position. Accordingly, each of the stopping blocks 310 remains fixed in the first position such that each of the lower drawers 210 are inhibited from opening.

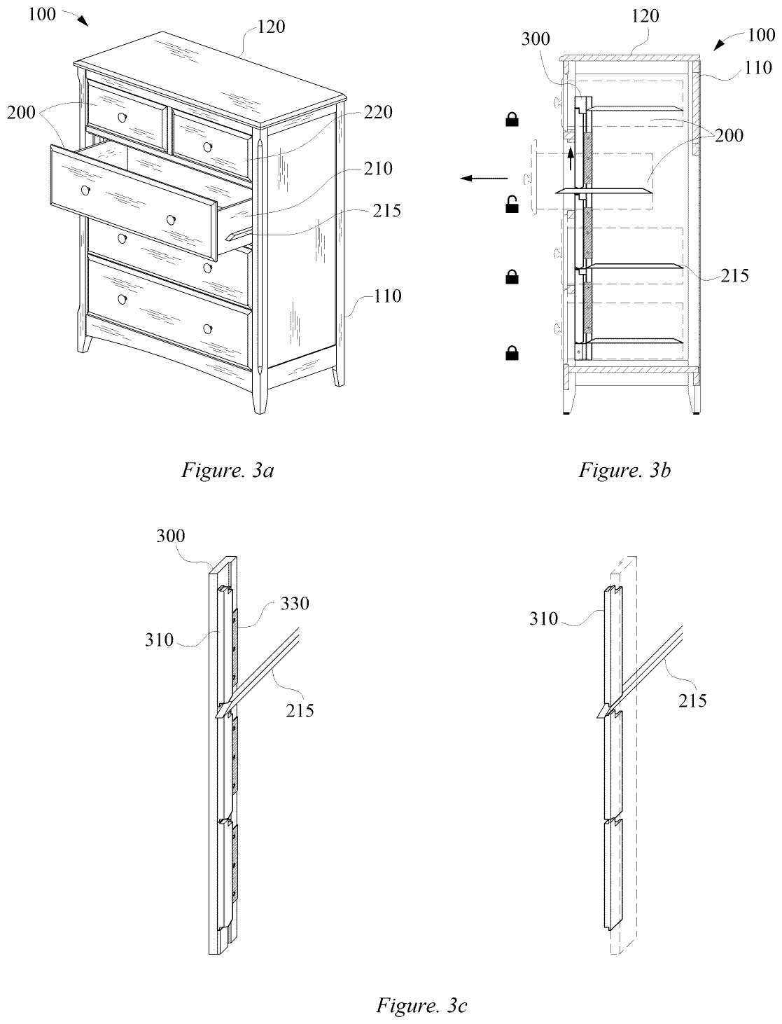

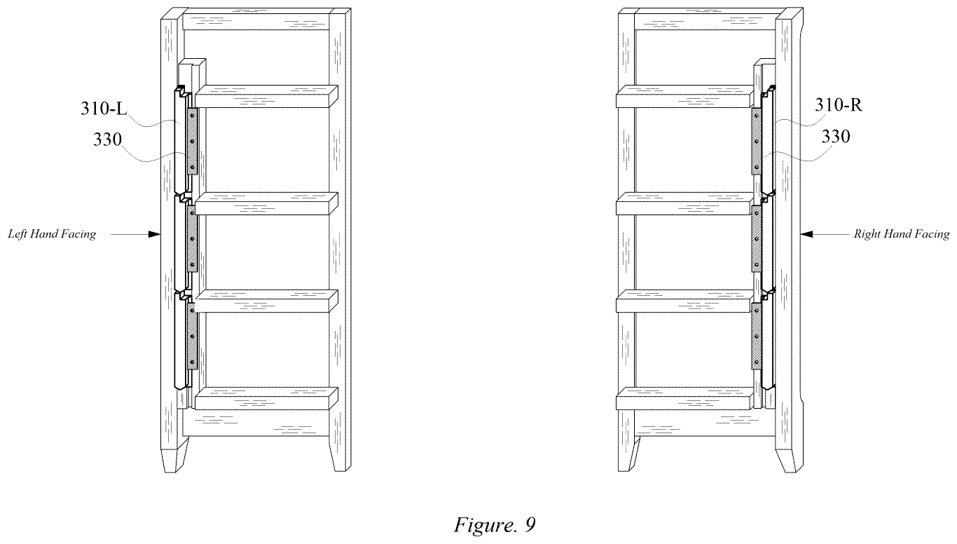

Likewise, as illustrated in FIGS. 3a to 3c, when other ones of the drawers 200 are opened, the stopping block 310 associated with the open drawer automatically move upwards within a shaft (see upwards arrow in FIG. 3b) due to the rail of the opened drawer (e.g., the curved end surface of the rail) pushing a respective one of the stopping block upward. As discussed in more detail below with regards to FIGS. 9-14, the shaft 320 in which the stopping blocks 310 move may be formed by a notch extending in a length direction within a vertical stile 150 of the frame 110 of the furniture apparatus 100. The notch may be covered by a metal plate 330 to form the shaft 320 in which each of the stopping blocks 310 move between the first position and the second position.

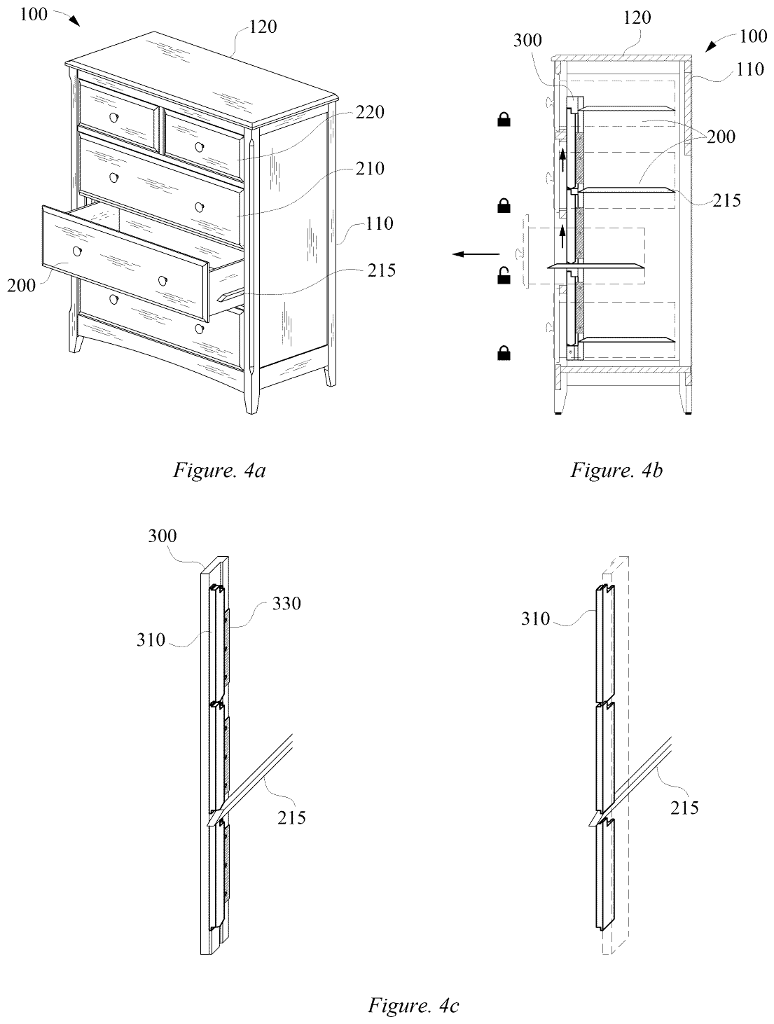

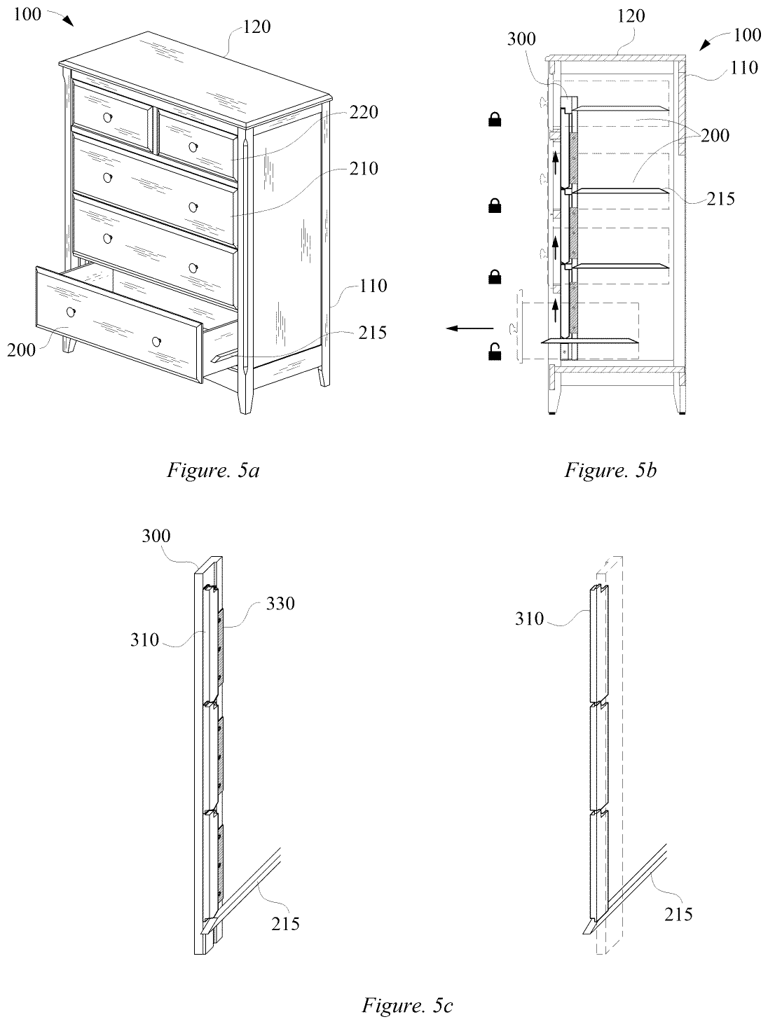

Further, as illustrated in FIGS. 4a to 4c and 5a to 5c, due to the stopping blocks 310 in the first position being in contact with each other within the shaft, this upward movement of the stopping block 310 may be propagated to cause other ones of the stopping blocks 310 associated with drawers 200 that are above the open drawer to also move upwards within the shaft (see upwards arrows in FIGS. 4b and 5b) due to the rail 215 of the drawer 200 pushing one of the stopping block 310 upwards and this shifted stopping block 310 pushing the rest of the stopping blocks 310 above the shifted stopping block 310 higher.

Referring to FIGS. 2a to 5c, at the same time, the stopping blocks 310 of the drawers 200 below the open drawer (that weren't pushed upwards) remain aligned to interact and inhibit opening of these lower drawers 200 and those stopping blocks 310 are inhibited from moving upwards when a user attempts to open the lower drawers 200 because these stopping blocks 310 hit the extended rail 215 of the higher adjacent open drawer 200. Therefore, only a single one of the drawers 200, either the upper drawer 220 (e.g., FIGS. 2a to 2c) or one of the lower drawers 210 therebelow (e.g., FIGS. 3a to 5c) may be open at a time. As such, the furniture apparatus 100 may not be easily unbalanced due to multiple drawers 200 being in an open position at the same time.

Additionally, once the rails 215 of one of the drawers 200 penetrates the shaft 320, none of the rails 215 of other ones of the drawers 200 may enter the shaft 120 due to the penetrating rail 215 blocking the stopping blocks 310 from vertically moving. Accordingly, the interlocking mechanism 300 according to example embodiments may not be easily circumvented and may inhibit the simultaneous action of opening two or more drawers 200 at the same time.

While FIGS. 1a to 5c illustrate the furniture apparatus 100 including the interlocking mechanism 300 as the sole anti-tipping mechanism, the furniture apparatus 100 may also include other additional anti-tipping mechanisms. For example, the furniture apparatus 100 may further include an anchor configured to secure an upper back of the furniture apparatus 100 to a wall or other support and/or a weighted base to prevent the furniture apparatus 100 from becoming top heavy.

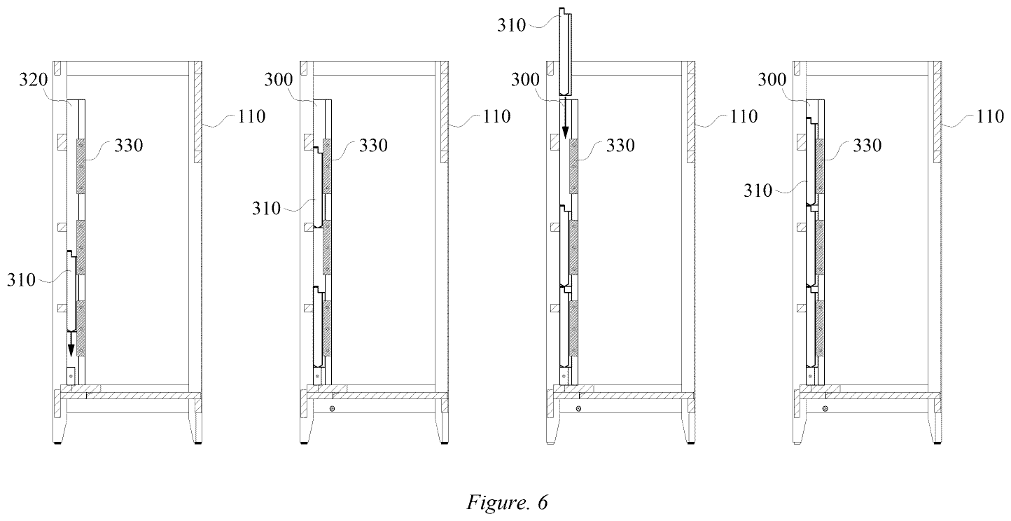

FIG. 6 illustrates a method of manufacturing a furniture apparatus including an anti-tipping mechanism according to example embodiments, and FIG. 7 illustrates the insertion or closing of a drawer of the furniture apparatus having an anti-tipping mechanism according to example embodiments.

Referring to FIGS. 6 and 7, after securing the metal plates 330 onto the notched vertical stile 150 to form the shaft 320, the stopping blocks 310 may be inserted one-by-one into the shaft 320 such that the stopping blocks 310 block the rails 215 of the drawers 200 from accessing the openings for the drawers 200. Thereafter, the top surface 120 of the furniture apparatus 100 may be installed. Thereafter, the drawers 200 may be inserted into the furniture apparatus 100 one-by-one such that, as each of the drawers 200 are closed, the sloped rear end surface of the pair of rails 215 may contact a respective one of the pair of stopping blocks 310 and cause the pair of stopping blocks 310 to move upwards to allow the drawer 200 to enter the furniture apparatus 100 (see arrows in FIG. 7). After all of the drawers 200 are inserted into the furniture apparatus 100, the stopping blocks 310 may be at the first position and the furniture apparatus 100 may be operable in the position shown in FIGS. 1a to 1c.

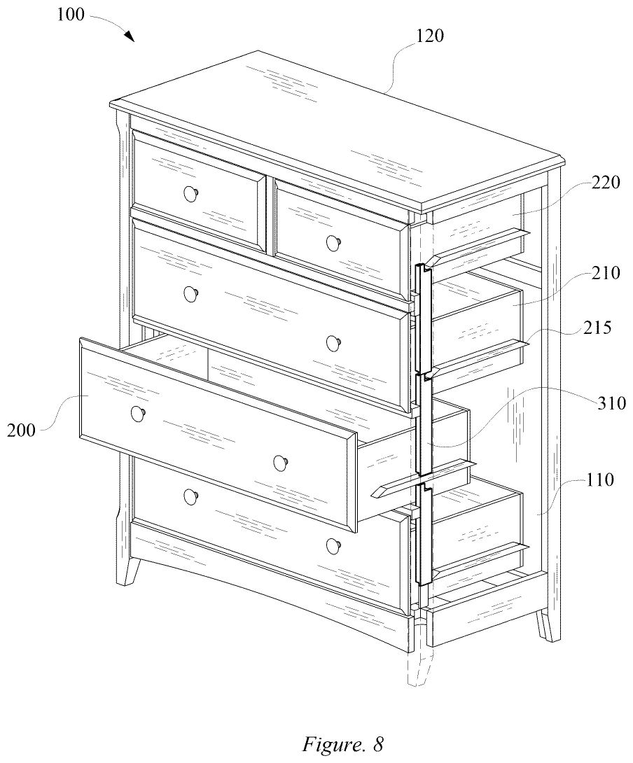

FIG. 8 illustrates a three-dimensional perspective view of a furniture apparatus with a side wall and support ledges omitted for illustration purposes according to example embodiments.

Referring to FIG. 8, when one of the drawers 200 is open, the stopping block(s) 310 above the open drawer 200 are shifted from the first position to the second position so that the side surface of notches in the top of the stopping blocks 310 thereabove inhibit opening of the drawers 200 higher in the frame 110 by interacting with the front end of the rails 215 of the drawers 200 higher up in the frame 110. Likewise, the stopping block(s) 310 below the open drawer 200 are held in the first position due to the top of the stopping blocks 310 interacting with the extended rail 215 of the open drawer 200 inhibiting the remainder of the stopping blocks 310 therebelow from moving upwards in the shaft 320.

While FIG. 8 illustrates that the furniture apparatus 100 includes the anti-tipping mechanism on the right hand facing side of the furniture apparatus 100, example embodiments are not limited thereto. For example, in other example embodiment, the left hand facing side of the furniture apparatus 100 may include the anti-tipping mechanism, while in still other example embodiment, both sides of the furniture apparatus 100 may include the anti-tipping mechanism such that each of the drawers 200 interacts with a pair of stopping blocks 310 arranged on each side of the furniture apparatus 100.

An anti-tipping mechanism on one side of the furniture apparatus 100 may be sufficient to inhibit opening of plural ones of the drawers 200, and the use of a single sided or a double sided anti-tipping mechanism is a matter of considering manufacturing cost efficiency, and the complexity of the particular drawer arrangement against increased stability and aesthetic appeal. A double sided anti-tipping mechanism may provide up to twice as much stability and may feel more secure to a user, when the anti-tipping mechanism locks the drawers closed, since a drawer that can only be locked on one side may have more play or jiggle on its opposite side. However, in practical terms, with a single sided anti-tipping mechanism, the drawers are still inhibited from being pulled out and therefore may be sufficiently locked for the purpose of addressing anti-tipping requirements.

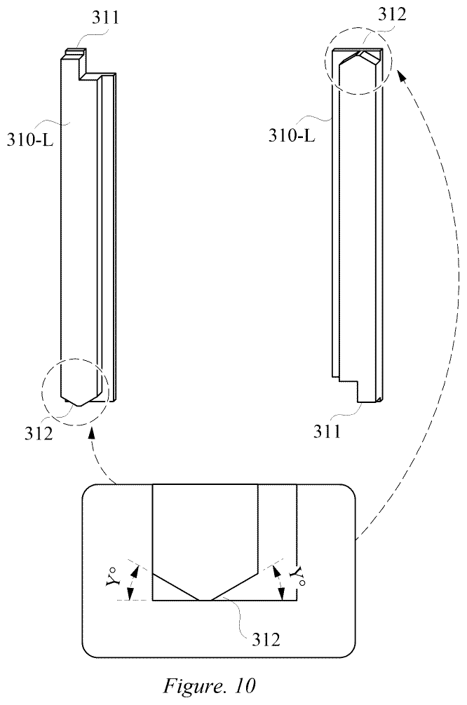

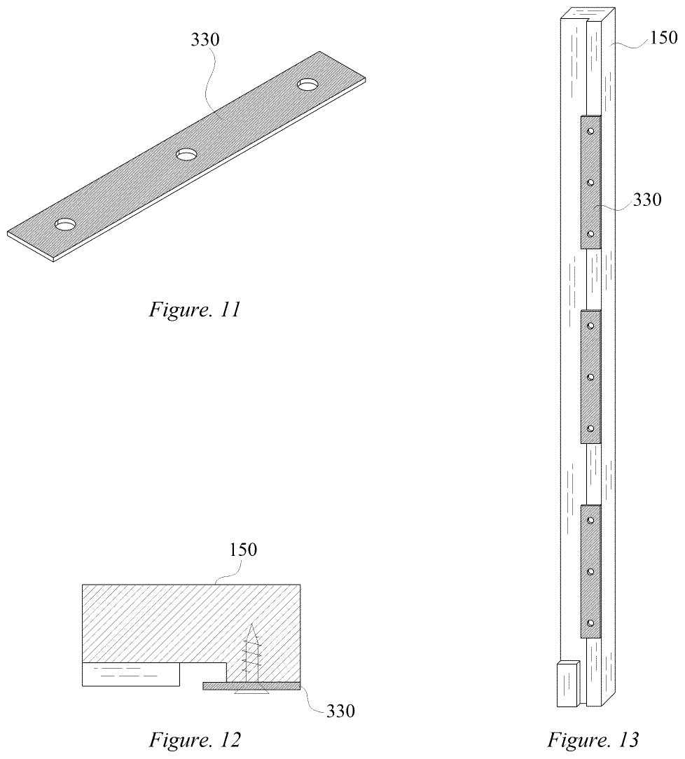

FIG. 9 illustrates left hand facing and right hand facing inside views of the side panels of a furniture apparatus according to example embodiments. FIG. 10 illustrates a stopping block included in an anti-tipping mechanism according to an example embodiment, and FIGS. 11 to 13 illustrate a shaft and a metal plate used to form the shaft according to example embodiments.

Referring to FIGS. 9 to 13, the shaft 320 may be formed by forming a notch in a vertical stile 150 (or, alternatively, a vertical rail) of the furniture apparatus 100 and attaching the metal plate 330 to the notched vertical stile 150 such that the metal plate 330 overhangs the notched portion and at least partially encloses the notch. The notch may be formed in the vertical stile 150 by cutting a recess, such as a rabbet, along a length of the vertical stile 150 so that the shaft is the L-shaped. The metal plate 330 may be attached to the vertical stile 150 using fasteners such as wood screws.

As shown in FIG. 9, the furniture apparatus 100 may include a pair of shafts 320. For example, when looking at the front of the furniture apparatus 100, the left hand facing side of the furniture apparatus 100 may have one shaft 320 and the right hand facing side of the furniture apparatus 100 may have another shaft 320. However, example embodiments are not limited thereto. For example, the interlocking mechanism 300 of the furniture apparatus 100 may include one or more shafts 320 having stopping blocks 310 therein each configured to interact with one of the pair of rails 215 on a side of the drawers 200. While a single shaft 320 on one side of the apparatus 100 would inhibit opening of the drawers 200, a design with stopping blocks 310 on both sides of the furniture apparatus 100 provides force on both ends of the drawers 200, thus, increasing the force holding the drawers 200 tightly closed.

As discussed above, the furniture apparatus 100 may include one or more rails 215 each configured to interact with stopping blocks 310 running in shafts 320 within the frame 100. These rails 215 that are part of interlocking mechanism may be a separate device from the drawer slide or runner (not shown) that supports the drawer 200 as the drawer moves in and out of the frame 100.

The stopping blocks 310 may include left hand facing stopping blocks 310-L and right hand facing stopping blocks 310-R, which are mirror images of each other, where each is configured to run within a respective one of the pair of shafts 320.

As shown in FIG. 10, each of the stopping block 310 may include an upper end 311 and a lower end 312. The upper end 311 may include a ledge that is shaped to fit into the L-shaped shaft. The lower end 312 of the stopping block 310 may have a sloped surface configured to interact with the rail of the lower one of the pair of drawers to cause the stopping block to move higher vertically from the first position to the second position. Further, the upper end of the stopping block 310 may have a notched surface configured to interact with the rail thereabove to inhibit opening of a corresponding drawer when the stopping block 310 is in the second (e.g., raised) position.

The sloped surface of the lower end 312 of the stopping blocks 310 may be wedged at an angle Y, while as shown in FIG. 39, discussed in more detail below, the side rails 215 of each of the drawers 200 may be beveled at an angle X. In the vertical stopping block configuration, the relationship between the beveled tip of an entering or exiting side rail 215 to the angled lower end 312 of a corresponding stopping block 310 produces a wedging action that converts the horizontal motion of the drawer 200 into a vertical lifting force, thereby effecting mechanical separation of two of the stopping blocks 310.

The specific angle X of the bevel of the side rail 215 and the angle Y of the wedged lower end 312 of the stopping block 310 are variable, and may be related to each other. For example, a rail tip angle of 25° may be utilized with a somewhat wider stopping-block wedge angle of 30°. However tighter, sharper angles may work also, for example, a 20° rail tip to and 25° stopping block wedged end may be utilized. As another example, a wider angle rail tip (e.g., 30°) and 25° angle stopping block wedge angle may be utilized as well. However, as the angles becomes sharper, the tip of the rails 215 and the lower end 312 of the stopping blocks 310 may become more fragile. Likewise, as the angles become wider, the interaction therebetween may become less smooth.

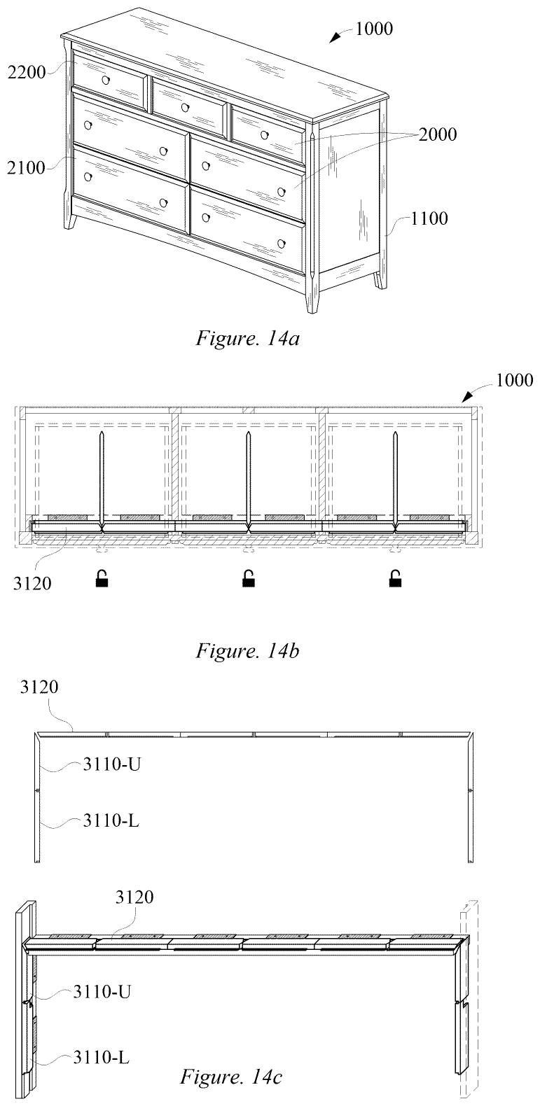

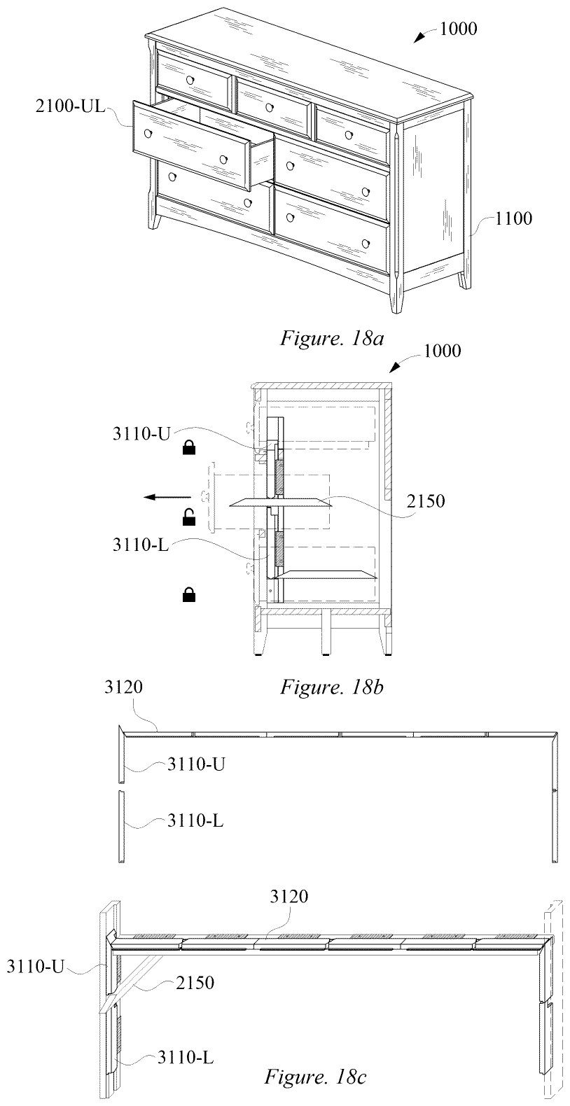

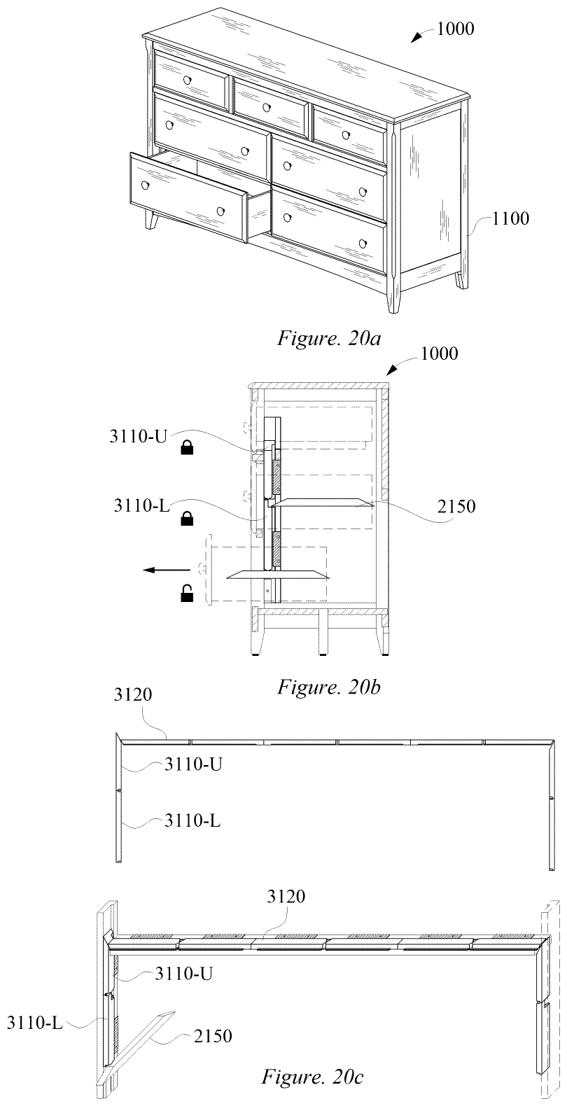

FIGS. 14a to 21c illustrates a furniture apparatus having an anti-tipping mechanism according to another example embodiments. FIGS. 14a, 15a, 16a, 17a, 18a, 19a, 20a, and 21a are three-quarter perspective views of a furniture apparatus in various states. FIGS. 14b, 15b, 16b, and 17b are top sectional views and FIGS. 18b, 19b, 20b, and 21b are side sectional views of an interlocking mechanism included in the furniture apparatus in the same various states. FIGS. 14c, 15c, 16c, 17c, 18c, 19c, 20c, and 21c are isolated views of an interlocking mechanism included in the furniture apparatus in the same various states.

Referring to FIGS. 14a to 21c, while example embodiments are discussed above with regards to the furniture apparatus 100 being a chest, the furniture apparatus is not limited thereto.

For example, some other example embodiments may be directed to a furniture apparatus 1000 that is a dresser, or any other furniture apparatus, having two or more sets of drawers 2000 arranged side-by-side in columns. In such a configuration each of the columns of drawers 2000 may include their own interlocking mechanism or there may be a common interlocking mechanism shared between columns of drawers 2000 arranged side-by-side.

In the furniture apparatus 100 discussed above, the chest of drawers 200 are all aligned in the same columns even though one or more of the rows of drawers 200, such as the upper row, are split into smaller sub-columns.

In the design of a furniture apparatus 1000 that is a dresser with multiple columns of drawers, where one of the rows of drawers, for example, the upper row of drawers 2000, includes drawers 2000 that are not aligned in the same column with other rows of the drawers 2000, it may be difficult to adequately secure each of the drawers 2000 from a side thereof, let alone from both sides of the drawers 2000, using only vertical stopping blocks. Therefore, as discussed below, in one or more example embodiments, the furniture apparatus 1000 may include both vertical and horizontal stopping blocks that are in communication and configured to interact with each other to inhibit the opening of more than any one of the drawers 2000 at the same time.

The furniture apparatus 1000 may include a frame 1100, a plurality of drawers 2000 and an anti-tipping mechanism 3000 in the form of an interlocking mechanism within the frame 1100 of the furniture apparatus 100. In some example embodiments, the plurality of drawers 2000 may include lower drawers 2100 and upper drawers 2200. The lower drawers 2100 may each have a pair of side rails 2150 fixedly attached to side surfaces thereof, while the upper drawers 2200 may have a bottom rail 2160 fixedly attached to a bottom surface thereof. In some example embodiments, the rails 2150, 2160 may have at least one sloped end surface. For example, at least a front end surface of the rails 2150, 2160 may be sloped to allow the front sloped end surface of the rails to interact with the interlocking mechanism when the drawers are opened. In other example embodiments both the front and rear end surfaces of the rails 2150, 2160 may be sloped to additional allow the rear slopped end surface of the rails 2150, 2160 to interact with the interlocking mechanism when the drawers 2000 are inserted into the furniture apparatus.

In some example embodiments, the interlocking mechanism 3000 may include stopping blocks 3100. The stopping blocks 3100 may include vertical stopping blocks 3110 and horizontal stopping blocks 3120. The vertical stopping blocks 3110 may include upper vertical stopping blocks 3110-U and lower vertical stopping blocks 3110-L.

The lower vertical stopping blocks 3110-L may be substantially similar to the stopping blocks 310 discussed above with regards to FIG. 10 and, as such, may be arranged to extend vertically within a vertical shaft 3200 that extends vertically within the frame 1100 such that each of the lower vertical stopping blocks 3110-L are configured to interact with respective pairs of the plurality of lower drawers 2100.

The horizontal stopping blocks 3120 may be arranged to extend horizontally within a shaft that extends horizontally within the frame between the lower drawers 2100 and the upper drawers 2200.

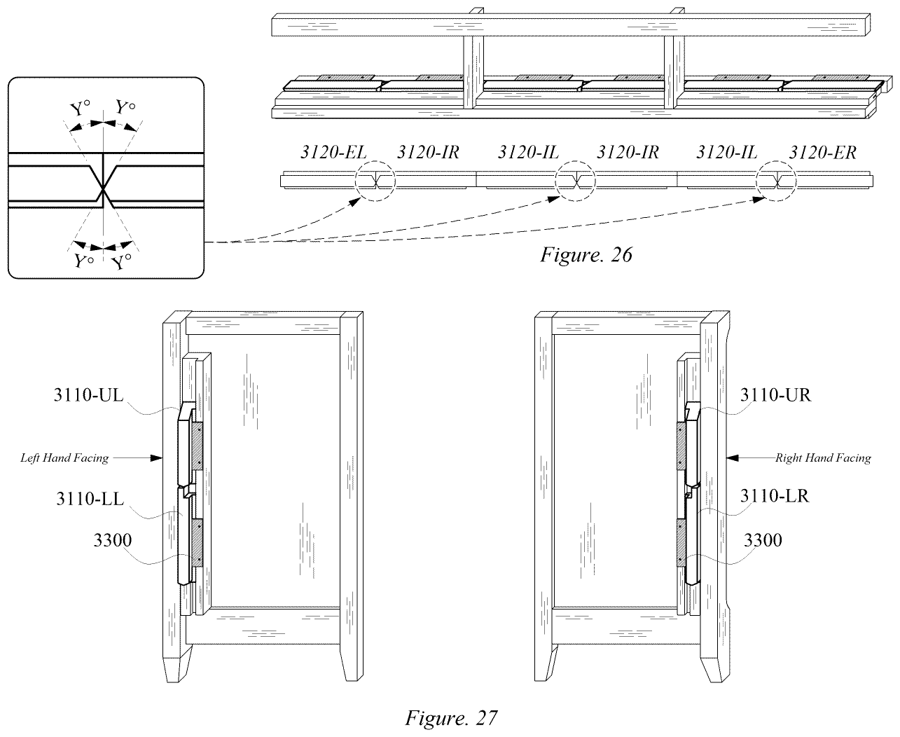

As shown in FIG. 26, the horizontal stopping blocks 3120 may include end horizontal stopping blocks 3120-EL, 3120-ER and interior horizontal stopping blocks 3120-IL, 3120-IR. The end horizontal stopping blocks 3120-EL, 3120-ER may include a left end horizontal stopping block 3120-EL and a right end horizontal stopping block 3120-ER. The interior horizontal stopping blocks 3120-IL, 3120-IR include left interior horizontal stopping blocks 3120-IL and right interior horizontal stopping blocks 3120-IR.

The bottom rail 2160 of the left end upper drawer 2200 is configured to interact with a pair of stopping blocks that include the left end horizontal stopping block 3120-EL and one of the right interior horizontal stopping blocks 3120-IR. The bottom rail 2160 of the middle upper drawer(s) 2200 are configured to interact with a pair of stopping blocks that include a left interior horizontal stopping block 3120-IL and a right interior horizontal stopping block 3120-IR. The bottom rail 2160 of the right end upper drawer 2200 is configured to interact with a pair of stopping blocks that include one of the left interior horizontal stopping blocks 3120-IL and the right end horizontal stopping block 3120-ER.

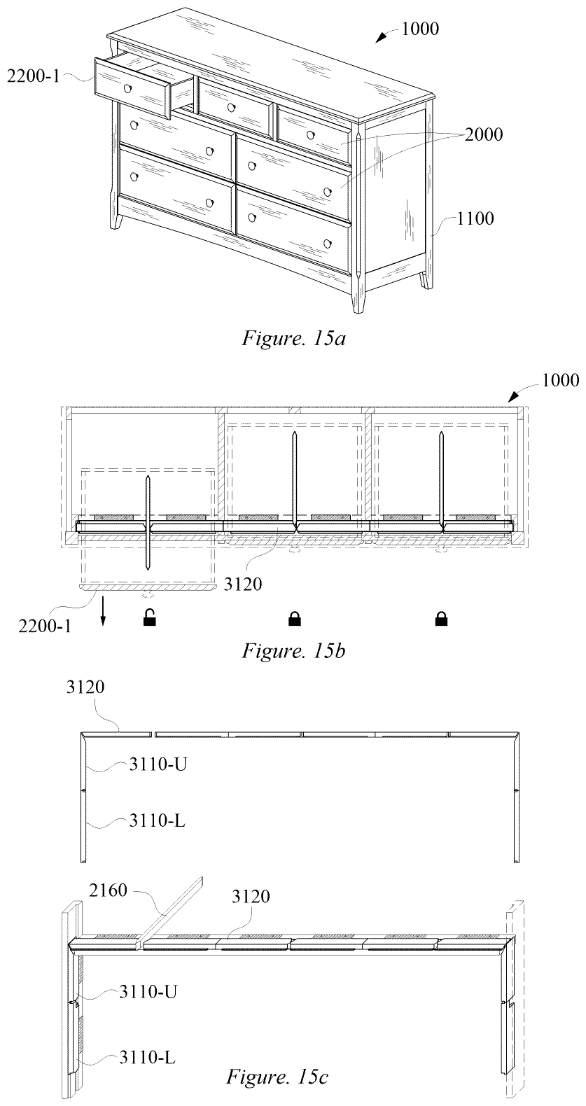

The upper vertical stopping blocks 3110-U may be configured to interact with both the upper end of the lower vertical stopping block 3110-L and the end horizontal stopping blocks 3120-EL, 3120-ER. For example, as shown in FIGS. 15c, 16c, and 17c, when one of the upper drawers 2200 is open, the horizontal stopping blocks 3120 associated with the open upper drawer 2200 split and force the end horizontal stopping blocks 3120-EL, 3120-ER to penetrate the vertical shafts 3200, thus, inhibiting any of the vertical stopping blocks 3110 from moving upwards, and, thus, none of the lower drawers 2100 may open.

As shown in FIGS. 14a-14c, when each of the drawers 2000 are closed and the furniture apparatus 1000 is at rest, each of the vertical stopping blocks 3110 and horizontal stopping blocks 3120 are in the first position such that one of the vertical stopping blocks 3110 is aligned to interact with the side rails 2150 of each of the drawers 2000 except the upper drawers 2200. Further, each pair of horizontal stopping blocks 3120 are aligned to interact with a corresponding bottom rail 2160 of one of the upper drawers 2200.

As shown in FIGS. 15a-15c, when the left end upper drawer 2200-1 is opened, the tapered end of the bottom rail 2160 of said upper drawer 2200-1 interacts with the left end horizontal stopping block 3120-EL and one of the right interior horizontal stopping blocks 3120-IR causing the left end horizontal stopping block 3120-EL to shift left into the left side vertical shaft 3200, thus blocking the vertical stopping blocks 3110 within the left shaft from moving upwards. Further, the right interior horizontal stopping blocks 3120-IR of the pair shifts to the right and thus forces each of the horizontal stopping blocks 3120 to the right thereof to shift further to the right. Accordingly, the left interior horizontal stopping block 3120-IL of the middle upper drawer 2200-2 blocks the middle upper drawer 2200-2 from being able to open, and the left interior horizontal stopping block 3120-IL of the left upper drawer 2200-3 blocks the left upper drawer 2200-3 from being able to open. Further, the right end horizontal stopping block 3120-ER shifts right into the right side vertical shaft 3200 thus blocking the vertical stopping blocks 3110 within the right shaft from moving upwards.

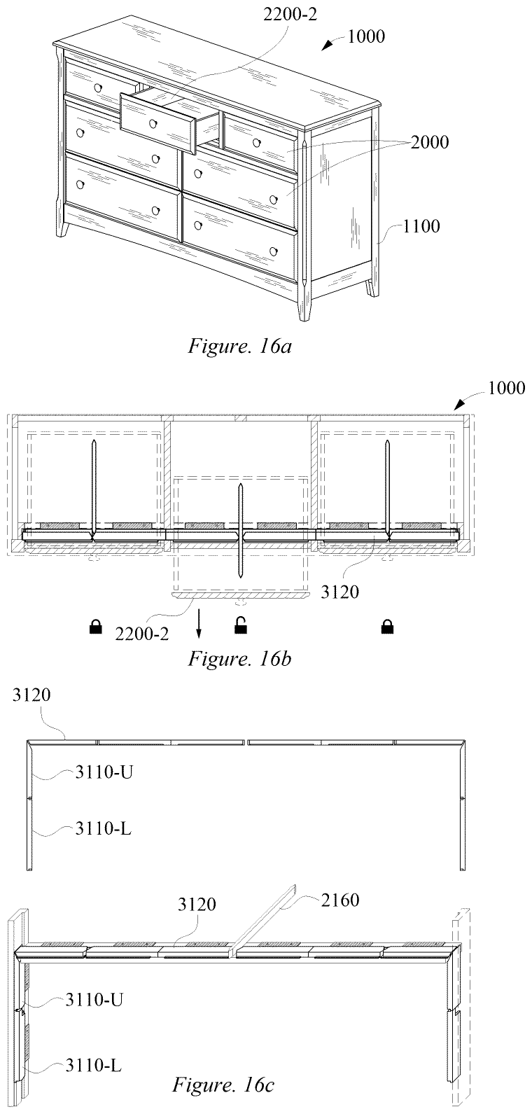

As shown in FIGS. 16a-16c, when the middle upper drawer 2200-2 is opened, the tapered end of the bottom rail 2160 of said upper drawer 2200-2 interacts with the pair of horizontal stopping blocks 3120 that include a left interior horizontal stopping block 3120-IL and a right interior horizontal stopping block 3120-IR causing the left interior horizontal stopping block 3120-IL to shift left and the right interior horizontal stopping block 3120-IR to shift right. The movement of the left interior horizontal stopping block 3120-IL to the left causes a right interior horizontal stopping block 3120-IR associated with the left upper drawer 2200-1 to inhibit the left upper drawer 2200-1 from opening, and causes the left end horizontal stopping block 3120-EL to shift left into the left side vertical shaft 3200 thus blocking the vertical stopping blocks 3110 within the left shaft from moving upwards. Further, the movement of the right interior horizontal stopping block 3120-IR to the right causes the left interior horizontal stopping block 3120-IL associated with the right upper drawer 2200-3 to inhibit the right upper drawer 2200-3 from opening, and causes the right end horizontal stopping block 120-ER to shift right into the right side vertical shaft 3200 thus blocking the vertical stopping blocks 3110 within the right side vertical shaft 3200 from moving upwards. Further, the right interior horizontal stopping blocks 3120-IR of the pair shifts to the right and thus forces each of the horizontal stopping blocks 3120 to the right thereof to shift further to the right. Accordingly, the left interior horizontal stopping block 3120-IL of the middle upper drawer 2200-2 blocks the middle upper drawer 2200-2 from being able to open, and the left interior horizontal stopping block 3120-IL of the left upper drawer 2200-3 blocks the left upper drawer 2200-3 from being able to open. Further, the right end horizontal stopping block 3120-ER shifts right into the right side vertical shaft 3200 thus blocking the vertical stopping blocks 3110 within the right shaft from moving upwards.

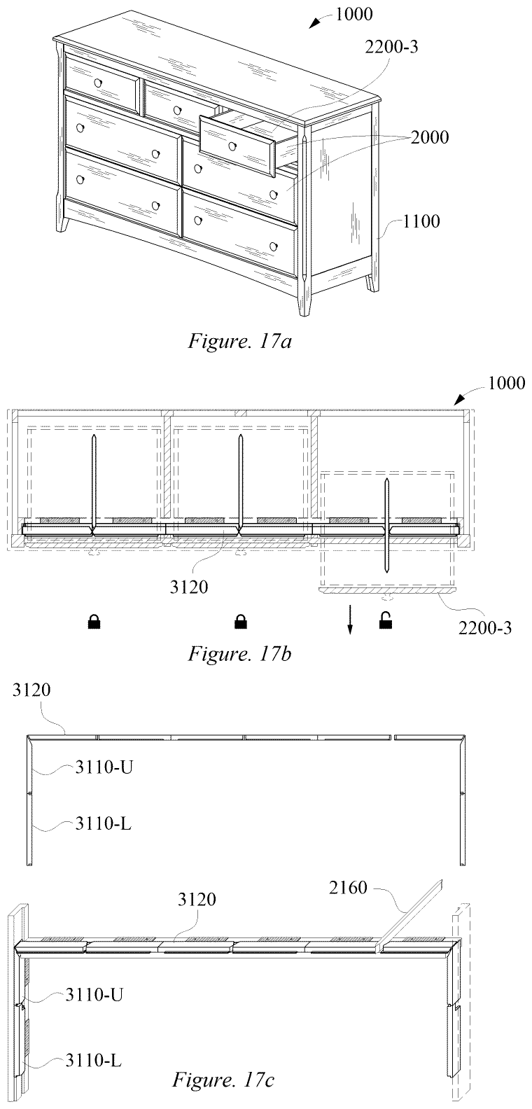

As shown in FIGS. 17a-17c, when the right end upper drawer 2200-3 is opened, the tapered end of the bottom rail 2160 of said upper drawer 2200-3 interacts with the right end horizontal stopping block 3120-ER and one of the left interior horizontal stopping blocks 3120-IL causing the right end horizontal stopping block 3120-ER to shift right into the right side vertical shaft 3200, thus blocking the vertical stopping blocks 3110 within the right shaft from moving upwards. For example, the end horizontal stopping blocks 3120-EL, 3120-ER may have a downward facing wedge/bevel with, for example, a 60° tip, such that, when the right end horizontal stopping block 3120-ER is displaced, it slides against and extend over the top of the end of an upper vertical stopping block 3110-U that finishes with an inward facing wedge/bevel with, for example, a 25° tip, thus inhibiting upward motion of the vertical stopping blocks 3110.

Further, the left interior horizontal stopping blocks 3120-IL of the pair shifts to the left and thus forces each of the horizontal stopping blocks 3120 to the left thereof to shift further to the left. Accordingly, the right interior horizontal stopping block 3120-IR of the middle upper drawer 2200-2 blocks the middle upper drawer 2200-2 from being able to open, and the right interior horizontal stopping block 3120-IR of the right upper drawer 2200-1 blocks the right upper drawer 2200-1 from being able to open. Further, the left end horizontal stopping block 3120-EL shifts left into the left side vertical shaft 3200 thus blocking the vertical stopping blocks 3110 within the left shaft from moving upwards.

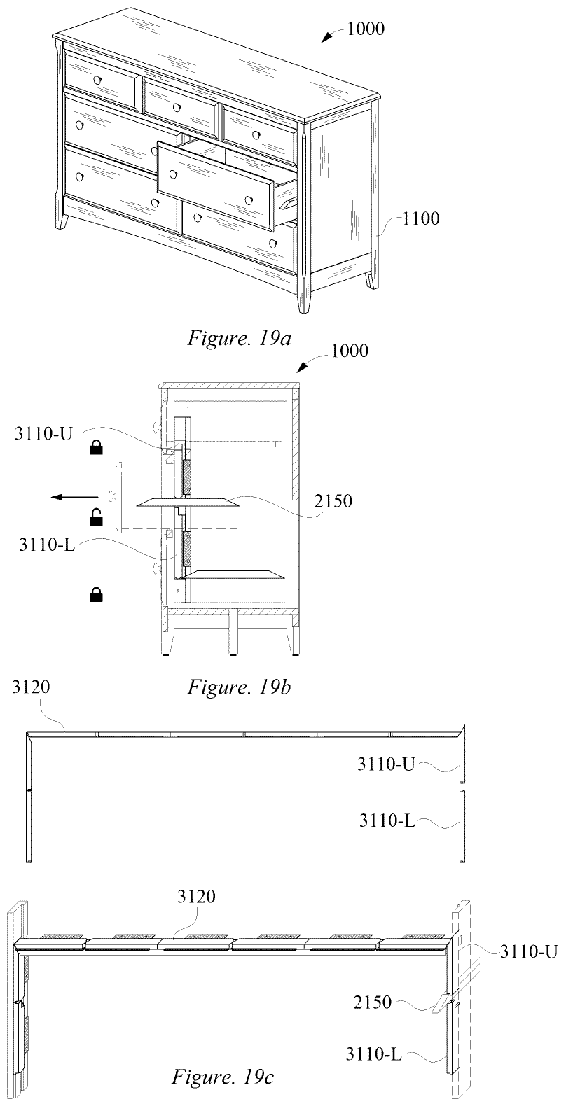

As discussed above, the horizontal stopping blocks 3120 may be arranged to extend horizontally within the shaft 3300 that extends horizontally within the frame between the lower drawers 2100 and the upper drawers 2200, and are configured to inhibit more than one of the upper drawers 2200 from being able to open at a time, and are configured to work in conjunction with the vertical stopping blocks 3110 such that, when one of the upper drawers 2200 are open, none of the lower drawers 2100 are openable. Further, as discussed below with reference to FIGS. 19a to 22c, the horizontal stopping blocks 3120 are configured to work in conjunction with the vertical stopping blocks 3110 such that, when one of the lower drawers 2100 are open, none of the upper drawers 2200 are openable.

As shown in FIGS. 18a-18c, when an upper left lower drawer 2100-UL is opened, the tapered end of one of the side rails 2150 of said lower drawer 2100-UL interacts with one of the upper vertical stopping blocks 3110-U within the left vertical shaft 3200 to move upwards, thus, inhibiting any of the horizontal stopping blocks 3120 from moving, and as such, each of the upper drawers 2200 are inhibited from opening. Further, as shown in FIG. 19c, as discussed above with regards to the first embodiment, the side rail 2150 of the open drawer 2100-UL blocks other ones of the vertical stopping blocks 3110 from being able to move upwards when a user attempts to open another one the lower drawers 2100 on the left side because these vertical stopping blocks 3110 hit the extended rail 2150 of the higher adjacent open drawer 2100-UL. Additionally, since each of the horizontal stopping blocks 3120 are inhibited from moving, the vertical stopping blocks 3110 associated with the other vertical shaft 3200 (e.g. the right vertical shaft are also inhibited from moving due to the right end horizontal stopping block 3120-ER positioned within the right side vertical shaft 3200, thus blocking the vertical stopping blocks 3110 within the right shaft 3200 from moving upwards.

FIGS. 19a-21c are somewhat similar to that of FIG. 18a-18c, and thus repetitive description thereof will be omitted.

As such, only a single one of the drawers 2000, either the upper drawer 2200 (e.g., FIGS. 15a to 17c) or one of the lower drawers 2100 therebelow (e.g., FIGS. 18a to 21c) may be open at a time. As such, the furniture apparatus 1000 may not be easily unbalanced due to multiple drawers being in an open position at the same time and may not be easily circumvented and may inhibit the simultaneous action of opening two or more drawers at the same time.

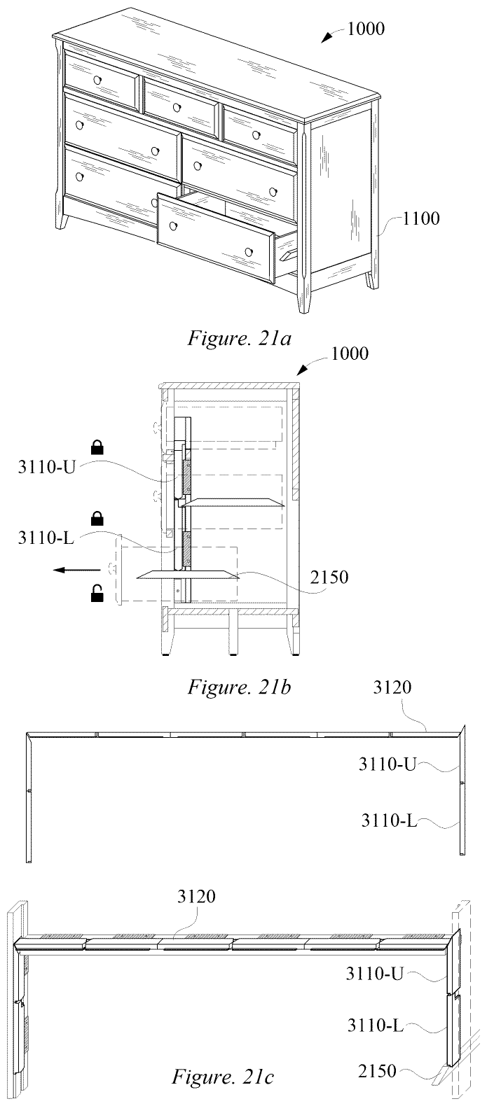

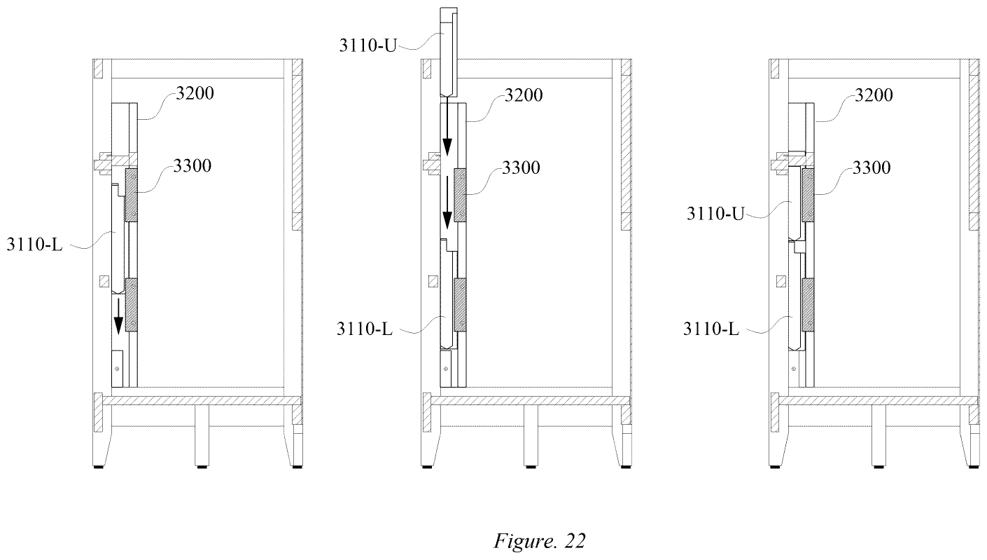

FIG. 22 illustrates a method of manufacturing a furniture apparatus including an anti-tipping mechanism according to example embodiments.

Referring to FIG. 22, similar to that discussed above with regards to FIG. 6, after securing the metal plates 3300 onto the notched vertical stile to form the vertical shaft 3200, the vertical stopping blocks 3110 may be inserted one-by-one into the vertical shaft 3200. Thereafter, the top surface 1200 of the furniture apparatus 1000 may be installed.

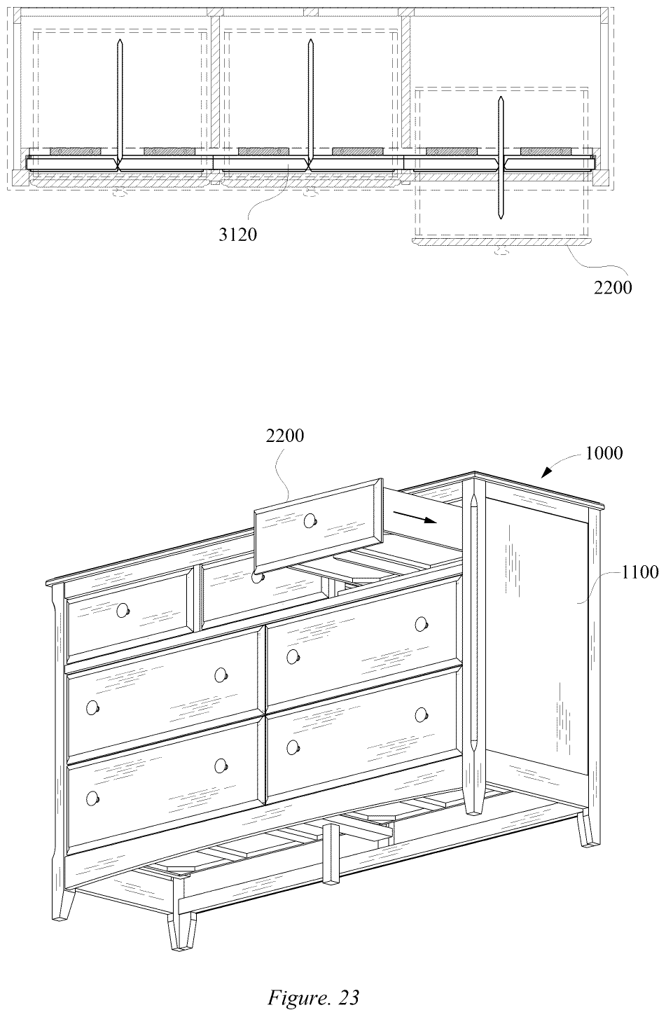

FIGS. 23 to 25 illustrates the insertion or closing of drawers of the furniture apparatus having an anti-tipping mechanism according to example embodiments.

Referring to FIG. 23, when one of the upper drawers 2200 is inserted into the furniture apparatus 1000, the bottom rail 2160 of said upper drawer 2200 may interact with a corresponding pair of the horizontal stopping blocks 3120 causing the pair of horizontal stopping blocks 3120 to move in opposite directions to allow for the upper drawer 2200 to be inserted.

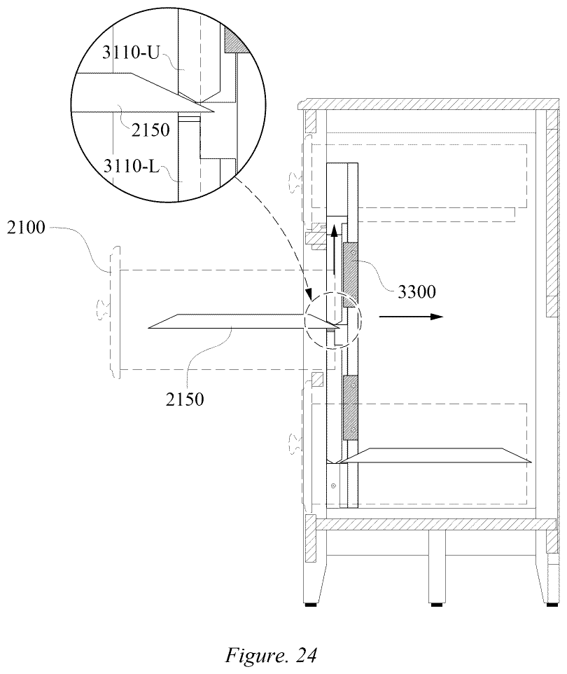

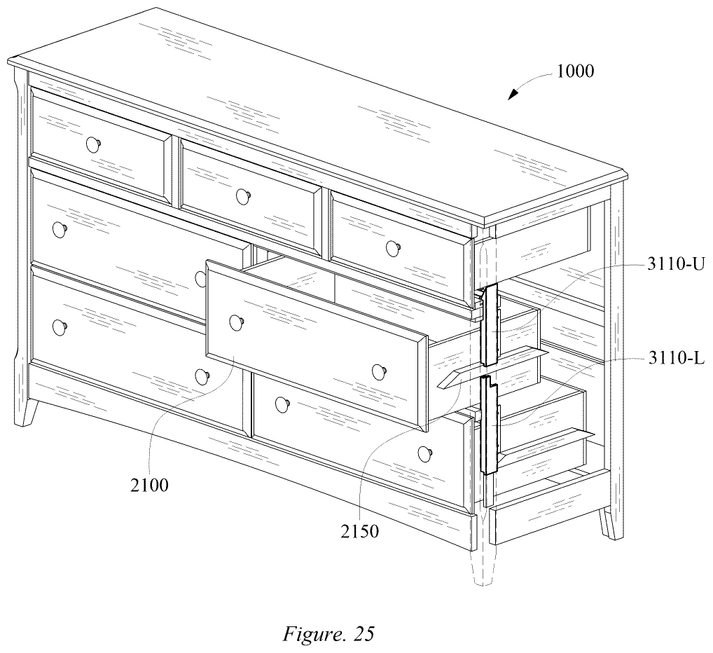

Referring to FIGS. 24 and 25, similarly, when one of the lower drawers 2100 is inserted into the furniture apparatus 1000, one of the side rails 2150 of said lower drawer 2100 may interact with a corresponding one of the vertical stopping blocks 3110 causing the vertical stopping block 3110 to move upward in the vertical shaft 3200 to allow the lower drawer 2100 to be inserted.

FIG. 26 illustrates an isolated front view of the anti-tipping mechanism in the frame of the furniture apparatus according to example embodiments.

Referring to FIG. 26, as discussed above, the horizontal stopping blocks 3120 may include end horizontal stopping blocks 3120-EL, 3120-ER and interior horizontal stopping blocks 3120-IL, 3120-IR. The end horizontal stopping blocks 3120-EL, 3120-ER may include a left end horizontal stopping block 3120-EL and a right end horizontal stopping block 3120-ER. The interior horizontal stopping blocks 3120-IL, 3120-IR include left interior horizontal stopping blocks 3120-IL and right interior horizontal stopping blocks 3120-IR. In some other example embodiments, since there is no drawer 2000 between the interior right IR and the interior left blocks IL, these blocks may be combined as a single block such as 3120-IR and 3120-IL are a single block.

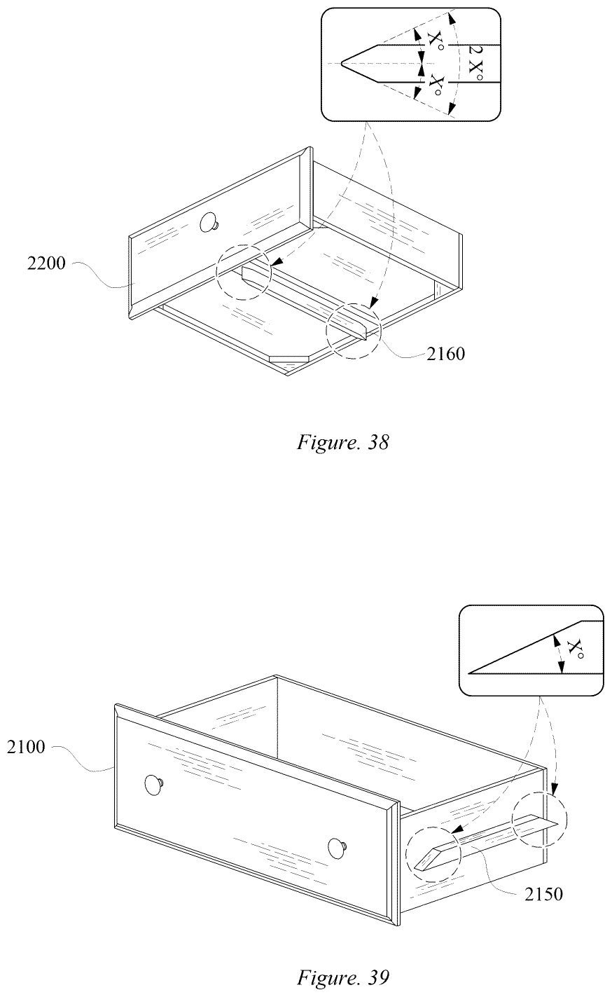

Similar to that discussed above with regards to FIG. 10, one end of the horizontal blocks that are configured to receive one of the bottom rails 2160 may be wedged at an angle Y, while as shown in FIG. 38, discussed in more detail below, the bottom rail 2160 of each of the upper drawers 2200 may be beveled at an angle X.

FIG. 27 illustrates left hand facing and right hand facing inside views of the side panels according to example embodiments.

Referring to FIG. 27, the furniture apparatus 1000, like the furniture apparatus 100, may include the vertical stopping blocks 3110. However, the furniture apparatus 1000 may include multiple columns of drawers 2000 such that one column of vertical stopping blocks 3110 only interacts with drawers 2000 in the left column and the other column of vertical stopping blocks 3110 only interact with drawers 2000 in the right column. For example, when looking at the front of the furniture apparatus 1000, the left hand facing side of the furniture apparatus 100 may have one vertical shaft 3200 and the right hand facing side of the furniture apparatus 100 may have another vertical shaft 3200, and the vertical stopping blocks 3110 may include left hand facing stopping blocks 3100-UL, 3100-LL and right hand facing stopping blocks 3100-UR, 3100 LR that are mirror images of each other, where each is configured to run within a respective one of the pair of vertical shafts 3200.

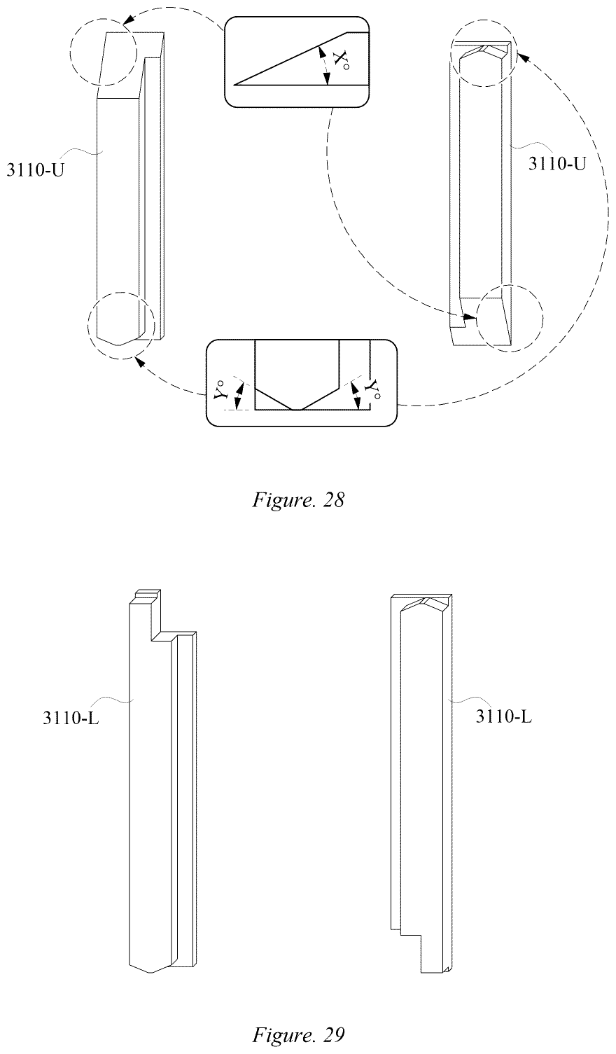

FIGS. 28 to 31 illustrate stopping blocks included in an anti-tipping mechanism according to according to example embodiments.

Referring to FIGS. 28 to 31, as discussed above, the vertical stopping blocks 3110 may include the upper vertical stopping blocks 3110-U and the lower vertical stopping blocks 3110-L and the horizontal stopping blocks may include end horizontal stopping blocks 3120-EL, 3120-ER and interior horizontal stopping blocks 3120-IL, 3120-IR.

FIG. 28 illustrates the upper vertical stopping blocks 3110-UL associated with the left vertical shaft 3200, and FIG. 29 illustrates the lower vertical stopping blocks 3110-LL associated with the left vertical shaft 3200. The upper vertical stopping blocks 3110-UR and the lower vertical stopping blocks 3110-LR associated with the right vertical shaft 3200 are not shown, however, such stopping blocks are mirror images of the illustrated upper vertical stopping blocks 3110-UL and the lower vertical stopping blocks 3110-LL associated with the left vertical shaft 3200, respectively, and thus repetitive description is omitted for the sake of brevity.

As shown in FIGS. 28 and 29, a lower end of each of the upper vertical stopping blocks 3110-U and lower vertical stopping blocks 3110-L may have a wedged surface, which is wedged at an angle Y. Further, as discussed above, the side rails 2150 of each of the drawers 2100 may be beveled at an angle X (see FIG. 39).

In the vertical stop-block configuration, the relationship between the beveled tip of an entering or exiting side rail 2150 to the angled end of a corresponding stopping blocks produces a wedging action that converts the horizontal motion of the drawer 2100 into a vertical lifting force, thereby effecting mechanical separation of the two of the lower vertical stopping blocks 3110-L.

Referring to the lower vertical stopping blocks 3110-L, similar to that discussed above with reference to FIG. 6, an upper end of the lower vertical stopping blocks 3110-L may include a ledge that is shaped to fit into the L-shaped shaft and a notched surface configured to interact with the rail of a drawer 2100 thereabove to inhibit opening of a corresponding drawer when the lower vertical stopping blocks 3110-L is in the second (e.g., raised) position.

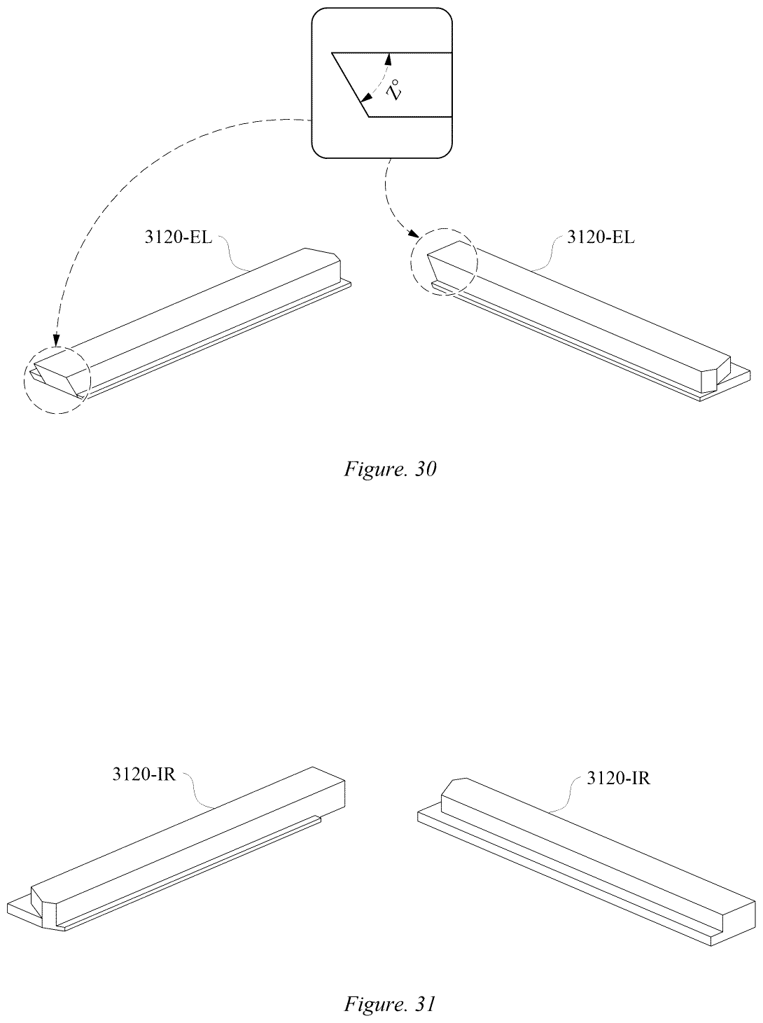

Referring to the upper vertical stopping blocks 3110-U, an upper end of the upper vertical stopping blocks 3110-U may be beveled at an angle X that corresponds to an angle Z of the end horizontal stopping blocks 3120-EL, 3120-ER, shown in FIG. 30.

FIG. 30 illustrates the left interior horizontal stopping block 3120-IL and the right end horizontal stopping block 3120-ER are not shown, however, such stopping blocks are mirror images of the illustrated right interior horizontal stopping block 3120-IR and the left end horizontal stopping block 3120-EL, respectively, and thus repetitive description is omitted for the sake of brevity.

In the horizontal stop-block configuration, the relationship between the arrowhead-shaped tip of the entering and exiting drawer-rail to the angled ends of the horizontal stopping blocks 3120 displaces the two horizontal stopping blocks 3120 away from the centerline-one to the left and the other to the right. This wedging action converts the drawer's linear motion into a transverse separating force, effecting side-to-side displacement of the horizontal stopping blocks 3120.

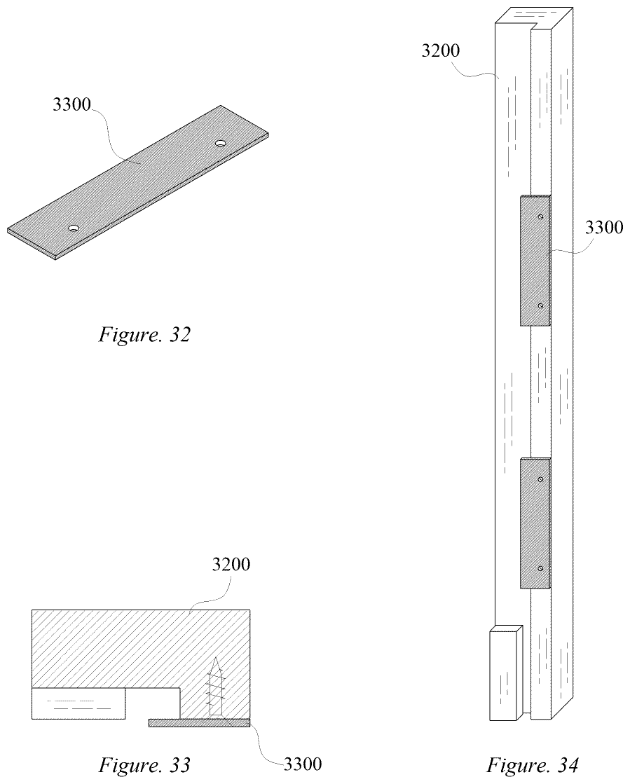

FIGS. 32 to 34 illustrate a shaft and a metal plate used to form the shaft according to some example embodiments.

Referring to FIGS. 32 to 34, similar to that discussed above with regards to FIGS. 11-13, in some example embodiments, the vertical shaft 3200 may be formed by forming a notch in a vertical stile (or, alternatively, a vertical rail) and attaching a metal plate 3300 to the notched vertical stile such that the metal plate 3300 overhangs the notched portion and at least partially encloses the notch. The notch may be formed in the vertical stile by cutting a recess, such as a rabbet, along a length of the vertical stile so that the shaft is the L-shaped. The metal plate 3300 may be attached to the vertical stile using fasteners such as wood screws. Likewise, the vertical stopping block 3100 may include a ledge that is shaped to fit into the L-shaped shaft. The lower end of the vertical stopping block 3100 may have a sloped surface configured to interact with the rail of the lower one of the pair of drawers to cause the stopping block to move higher vertically from the first position to the second position. Further, the upper end of the vertical stopping blocks 3100 may have a notched surface configured to interact with the rail thereabove to inhibit opening of a corresponding drawer when the vertical stopping block 3100 is in the second (e.g., raised) position.

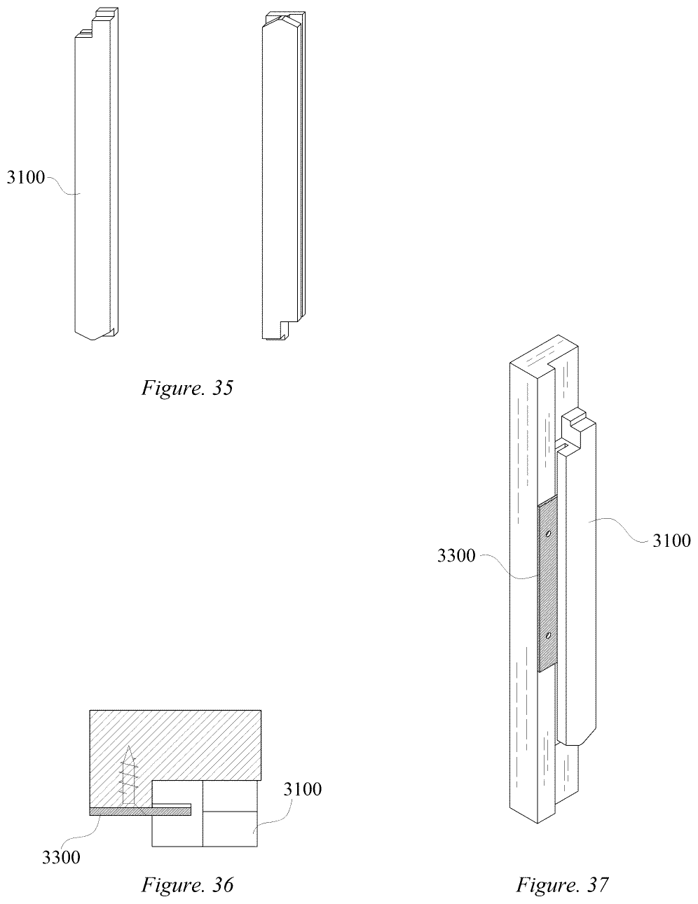

FIGS. 35 to 37 illustrate a shaft and a metal plate used to form the shaft according to some other example embodiments.

Referring to FIGS. 35 to 37, in other example embodiments, the vertical stopping blocks 3100 may include a notch therein that is configured to fit within the metal plate 3300 to guide the vertical stopping blocks 3100 within the vertical shaft 3200. By guiding the vertical stopping blocks 3100, the movement of the vertical stopping blocks may be smoother and quieter.

FIG. 38 illustrates an upper drawer according to example embodiments. FIG. 39 illustrates a lower drawer according to example embodiments.

Referring to FIGS. 38 and 39, as discussed above, the upper drawers 2200 may include a bottom rail 2160 attached to a bottom surface thereof, while the lower drawers 2100 may include side rails 2150 attached to side surfaces thereof, where at least one of the pair of side rails 2150 may be configured to interact with a corresponding stopping block arranged within a shaft in the frame 1100 of the furniture apparatus 1000. The lower drawers 2100 may have the same design as the drawers 200 of the furniture apparatus 100 with a pair of rails 215 on each side thereof.

As discussed above, in one or more example embodiments, a furniture apparatus may inhibit opening of multiple drawers, which may cause the furniture apparatus to tip over, without requiring the furniture apparatus to be secured to a wall or other support, Further, since the stopping blocks and the interior of the L-shaped shaft may be wood strips formed from wood remnants, which are readily available within most furniture factories, the interlocking mechanism may be manufactured using the same machinery used to manufacture the furniture apparatus. As such, a manufacturer may not have to rely on outside sources and/or purchase new tools capable of molding, for example, plastics. Instead, the entirety of the interlocking mechanism may be formed from wood except for the readily available flat metal plate used to enclose the L-shaped shaft. Accordingly, the furniture apparatus provides a simple and cost effective anti-tipping mechanism that may not be easily circumvented.

Further, in some example embodiments, even when the drawer arrangement may be complex and not aligned in the same columns and, thus, may be difficult to integrate into the same interlocking system, example embodiments may utilize separate interlocking systems, such as a vertical system and a horizontal system, that are configured to communicate and operate together to inhibit opening of multiple ones of the drawers. Further, while separate interlocking systems may generally increase the costs and complexity as compared to a single interlocking system, the cost efficiency and complexity associated with multiple interlocking systems may be addressed by having each of the interlocking mechanisms configured to interact with only one side (e.g., the left hand facing side or the right hand facing side) of each of the drawers.

The description of the disclosure is merely example in nature and, thus, variations that do not depart from the spirit of the disclosure are intended to be within the scope of the disclosure. Such variations are not to be regarded as a departure from the spirit and scope of the disclosure.

What is claimed:

1. An anti-tipping apparatus configured to inhibit opening of plural ones of a plurality of drawers, the anti-tipping apparatus comprising:
at least one shaft; and
stopping blocks arranged to move within the at least one shaft when the stopping blocks interact with rails attached to drawers such that, when one of the drawers opens, a pair of the stopping blocks are split by one or more of the rails to reposition one or more of the stopping blocks such that other ones of the drawers are inhibited from being opened by one of the one or more stopping blocks that are repositioned.

2. The anti-tipping apparatus of claim 1, wherein the stopping blocks comprise one or more of:
vertical stopping blocks each configured to interact with side rails fixedly attached to side surfaces of a respective one of the drawers; and
horizontal stopping blocks each configured to interact with a bottom rail fixedly attached to a bottom surface of a respective one of the drawers.

3. The anti-tipping apparatus of claim 2, wherein
the vertical stopping blocks include lower vertical stopping blocks and a set of upper vertical stopping block, and
the horizontal stopping blocks include pairs of interior horizontal stopping blocks and a pair of end horizontal stopping blocks.

4. The anti-tipping apparatus of claim 3, wherein
the lower vertical stopping blocks are configured to interact with the side rails fixedly attached to side surfaces of the plurality of drawers when corresponding ones of the plurality of drawers are opened or closed, and
the set of upper vertical stopping blocks are configured to interact with respective ones of pair of end horizontal stopping blocks when corresponding ones of the plurality of drawers are opened or closed.

5. A furniture apparatus, comprising:
the anti-tipping apparatus of claim 1; and
the plurality of drawers each having the one or more rails fixedly attached to side surfaces or a bottom surface thereof, the one or more rails having a sloped end surface.

6. The furniture apparatus of claim 5, further comprising:
a frame including stiles each forming one of the at least one shaft.

7. An anti-tipping apparatus configured to inhibit opening of plural ones of a plurality of drawers, anti-tipping apparatus comprising:
an interlocking mechanism including stopping blocks arranged within a shaft in a direction perpendicular to one or more rails fixedly attached to side surfaces of the plurality of drawers, the stopping blocks configured to interact with the one or more rails such that,
when each of the plurality of drawers are closed, each of the stopping blocks are in a first position to interact with at least respective ones of the plurality of drawers below an uppermost one of the plurality of drawers, and
when one of the plurality of drawers is an open drawer, the stopping blocks associated with the open drawer and ones of the plurality of drawers thereabove are positioned at a second position within the shaft in response to a sloped end surface of a corresponding one of the one or more rails of the open drawer contacting a respective one of the stopping blocks to inhibit the opening of the ones of the plurality of drawers above the open drawer while the stopping blocks below the open drawer remain in the first position and are inhibited from moving vertically to the second position due to extension of the corresponding one of the one or more rails to inhibit opening of ones of the plurality of drawers below the open drawer.

8. The anti-tipping apparatus of claim 7, wherein a number of the stopping blocks is at least one less than a number of the plurality of drawers, and each of the stopping blocks are configured to interact with a respective pair of drawers of the plurality of drawers such that,
in the first position, each of the stopping blocks inhibits opening of a lower one of the respective pair of drawers, and
in the second position, each of the stopping blocks inhibits opening of an upper one of the pair of drawers.

9. The anti-tipping apparatus of claim 8, wherein the stopping blocks have a sloped lower end surface configured to interact with one of the one or more rails of the lower one of the respective pair of drawers when in the first position and a notched upper end surface configured to interact with one of the one or more the rails of the upper one of the respective pair of drawers when in the second position.

10. The anti-tipping apparatus of claim 7, wherein the one or more rails each include at least one sloped end surface.

11. The anti-tipping apparatus of claim 7, wherein a front end and a rear end of each of the one or more rails are sloped such that a front end surface interacts with one of the stopping blocks when one of the plurality of drawers is opened and a rear end surface interacts with one of the stopping blocks when one of the plurality of drawers is inserted.

12. The anti-tipping apparatus of claim 7, wherein the stopping blocks are formed of strips of wood.

13. The anti-tipping apparatus of claim 7, further comprising:
a stile having a rabbet extending in a length direction thereof such that the stile includes a first portion and a second portion with the first portion being narrower than the second portion in a direction perpendicular to the length direction; and
a plate attached to the stile and extending to cover a portion of the rabbet to create the shaft for the stopping blocks within the stile.

14. The anti-tipping apparatus of claim 13, wherein the stopping blocks each include a ledge extending from a side surface thereof such that the ledge is configured to travel within the rabbet in the stile.

15. The anti-tipping apparatus of claim 7, wherein while one or more of the stopping blocks is held in the second position by an open one of the plurality of drawers, the anti-tipping apparatus inhibits opening of another one of the plurality of drawers.

16. The anti-tipping apparatus of claim 7, wherein, when two or more of the plurality of drawers are attempted to be opened simultaneously, the anti-tipping apparatus inhibits opening of each of the two or more of the plurality of drawers such that none of the plurality of drawers are openable.

17. A method of manufacturing an anti-tipping apparatus configured to inhibit opening of plural ones of a plurality of drawers, the method comprising:
inserting stopping blocks into a frame of a furniture apparatus such that the stopping blocks are arranged within a shaft in a first direction perpendicular to one or more rails fixedly attached to side surfaces of the plurality of drawers, the stopping blocks configured to interact with the one or more rails such that,
when each of the plurality of drawers are closed, each of the stopping blocks are in a first position to interact with at least respective ones of the plurality of drawers below an uppermost one of the plurality of drawers, and
when one of the plurality of drawers is an open drawer, the stopping blocks associated with the open drawer and ones of the plurality of drawers thereabove move vertically within the shaft to a second position in response to a sloped end surface of a corresponding one of the one or more rails of the open drawer contacting a respective one of the stopping blocks to inhibit the opening of the ones of the plurality of drawers above the open drawer while the stopping blocks below the open drawer remain in the first position and are inhibited from moving vertically to the second position due to extension of the corresponding one of the one or more rails to inhibit opening of ones of the plurality of drawers below the open drawer, wherein the stopping blocks are formed of strips of wood.

18. The method of claim 17, wherein the inserting inserts a number of the stopping blocks such that the number of the stopping blocks is at least one less than a number of the plurality of drawers, and each of the stopping blocks are configured to interact with a respective pair of drawers of the plurality of drawers such that,
in the first position, each of the stopping blocks inhibits opening of a lower one of the respective pair of drawers, and
in the second position, each of the stopping blocks inhibits opening of an upper one of the pair of drawers.

19. The method of claim 17, further comprising:
securing plates to a stile having a rabbet extending in a length direction thereof such that the plates cover a portion of the rabbet to create the shaft for the stopping blocks within the stile.

20. An anti-tipping apparatus configured to inhibit opening of plural ones of a plurality of drawers, the anti-tipping apparatus comprising:
an interlocking mechanism including,
sets of horizontal stopping blocks configured to interact with a rail fixedly attached to a bottom of a respective one of the plurality of drawers; and
vertical stopping blocks including lower vertical stopping blocks and a set of upper vertical stopping blocks, the lower vertical stopping blocks configured to interact with one or more rails fixedly attached to side surfaces of the plurality of drawers, and the set of upper vertical stopping blocks configured to interact with respective end horizontal stopping blocks among the sets of horizontal stopping blocks, wherein
when each of the plurality of drawers are closed, each of the lower vertical stopping blocks are in a first position to interact with respective ones of the plurality of drawers except an uppermost one of the plurality of drawers and the sets of horizontal stopping blocks are free to move horizontally in opposite directions when the rail fixedly attached to the bottom of a respective one of the plurality of drawers associated with the set of horizontal stopping blocks moves while the drawer is opened, and
when a lower one of the plurality of drawers is an open drawer, the vertical stopping blocks associated with the open drawer and ones of the plurality of drawers thereabove are at a second position different from the first position in response to a sloped end surface of a corresponding one of the one or more rails of the open drawer contacting a respective one of the vertical stopping blocks to inhibit the opening of the ones of the plurality of drawers above the open drawer while the vertical stopping blocks below the open drawer remain in the first position and are inhibited from moving vertically to the second position due to extension of the corresponding one of the one or more rails to inhibit opening of ones of the plurality of drawers below the open drawer, and
when one of the uppermost one of the plurality of drawers is an open drawer, the horizontal stopping blocks associated with the open drawer move horizontally in opposite directions to both inhibit other ones of the sets of horizontal stopping blocks from being movable horizontally such that other uppermost ones of the plurality of drawers are inhibited from opening while the respective end horizontal stopping blocks are positioned to inhibit the vertical stopping blocks from being movable vertically from the first position to the second position such that each of the lower ones of the plurality of drawers is inhibited from opening.
